(19) United States
(12) Patent Application Publication
(10) Pub. No.: US 2011/0175939 A1
(43) Pub. Date: Jul. 21, 2011

(54) DISPLAY DEVICE

(75) Inventors: Hiroaki MORIYAMA, Kanagawa (JP); Yoshinori MACHIDA, Kanagawa (JP); Yasuo YAMAMOTO, Kanagawa (JP)

(73) Assignee: FUJI XEROX CO., LTD., Tokyo (JP)

(21) Appl. No.: 12/874,812

(22) Filed: Sep. 2, 2010

(30) Foreign Application Priority Data
Jan. 18, 2010 (JP) 2010-008480

(51) Int. Cl. G09G 3/34; G09G 5/10

(52) U.S. Cl. 345/690; 345/107

(57) ABSTRACT

The invention provides a display device including a display medium, the display medium including a pair of substrates positioned so as to have a space therebetween, at least one of the substrates having translucency; a pair of electrodes respectively being positioned on the pair of substrates, the electrode positioned on the substrate having translucency having translucency; a dispersion medium positioned between the pair of electrodes; and first particles and second particles being dispersed in the dispersion medium and having different colors and different charge polarities, the first particles and the second particles electrophoretically moving independently from each other when a first voltage potential difference is applied between the pair of electrodes, and the first particles and the second particles electrophoretically moving while forming a positively or negatively charged flocculation when a second voltage potential difference that is smaller than the first voltage potential difference is applied between the pair of electrodes.

### CROSS-REFERENCE TO RELATED APPLICATION

This application is based on and claims priority under 35 USC 119 from Japanese Patent Application No. 2010-008480 filed Jan. 18, 2010.

### BACKGROUND

1. Technical Field

The present invention relates to a display device.

2. Related Art

Display media in which electrophoretic particles are used are known as rewritable display media. This type of electrophoretic display media include, for example, a pair of substrates positioned so as to face each other, each being provided with an electrode, and particles enclosed between the substrates in such a manner that the particles can move between the substrates in accordance with an electric field formed between the substrates.

The particles enclosed between the pair of substrates may be a single kind of particles having a specific color, or may be a combination of two or more kinds of particles having different colors and different levels of electric field intensity that is necessary for the particles to move. For example, when the display device include two kinds of particles, an image is formed by moving the enclosed particles by applying a voltage between the pair of substrates, in accordance with the color or the amount of the particles that have moved to the side of one of the substrates. More specifically, by applying a voltage at an intensity with which the particles can move between the substrates, in accordance with the color and the density of an image to be displayed, the particles that are intended to be moved are moved to one of the pair of substrates, thereby displaying an image according to the color and the density of the image to be displayed.

### SUMMARY

According to an aspect of the invention, there is provided a display device comprising a display medium comprising:

a pair of substrates positioned so as to have a space therebetween, at least one of the substrates having translucency;

a pair of electrodes respectively being positioned on the pair of substrates, the electrode positioned on the substrate having translucency having translucency;

a dispersion medium positioned between the pair of electrodes; and

at least two kinds of particles being dispersed in the dispersion medium, the at least two kinds of particles comprising first particles and second particles having different colors and different charge polarities,

the first particles and the second particles electrophoretically moving independently from each other when a first voltage potential difference is applied between the pair of electrodes,

the first particles and the second particles electrophoretically moving while forming a positively or negatively charged flocculation when a second voltage potential difference that is smaller than the first voltage potential difference is applied between the pair of electrodes, and

the display device performing voltage application comprising:

applying the first voltage potential difference to the pair of electrodes at which the first particles and the second particles electrophoretically move independently from each other and are attracted to either one of the pair of electrodes depending on the charge polarity of the first particles and the second particles, respectively; and

applying the second voltage potential difference to the pair of electrodes at which the first particles and the second particles electrophoretically move while forming a positively or negatively charged flocculation, and the flocculation is attracted to either one of the pair of electrodes depending on the charge polarity of the flocculation.

### BRIEF DESCRIPTION OF THE DRAWINGS

Exemplary embodiments of the present invention will be described in detail based on the following figures, wherein:

FIG. 1 is a schematic diagram showing a display device according to a first exemplary embodiment of the invention:

FIG. 2 is a schematic diagram showing the behavior of the electrophoretic particles according to the voltage application in the display device according to the first exemplary embodiment of the invention;

FIG. 3 is a schematic diagram showing the behavior of the electrophoretic particles according to the voltage application in a display device according to a second exemplary embodiment of the invention;

FIG. 4 is a schematic diagram showing the behavior of the electrophoretic particles according to the voltage application in a display device according to a third exemplary embodiment of the invention;

FIG. 5 is a schematic diagram showing the behavior of the electrophoretic particles according to the voltage application in a display device according to a fourth exemplary embodiment of the invention; and

FIG. 6 is a schematic diagram showing the behavior of the electrophoretic particles according to the voltage application in a display device according to a fifth exemplary embodiment of the invention.

### DETAILED DESCRIPTION

The present inventors have found that when an image is displayed according to the colors of two or more kinds of electrophoretic particles, some combinations of the electrophoretic particles of different kinds form a flocculation while moving according to the intensity and the time of the voltage applied between the electrodes, and move as a flocculation. The present inventors have also found that by using particles that electrically migrate either independently or collectively as a flocculation depending on the voltage applied between the electrodes, and controlling the voltage applied between the electrodes, a color derived from the flocculation formed from particles of different kinds can be expressed.

Specifically, one exemplary embodiment according to the present invention is a display device including a display medium including:

a pair of substrates positioned so as to have a space therebetween, at least one of the substrates having translucency;

a pair of electrodes respectively being positioned on the pair of substrates, the electrode positioned on the substrate having translucency having translucency;

a dispersion medium positioned between the pair of electrodes; and

at least two kinds of particles being dispersed in the dispersion medium, the at least two kinds of particles including first particles and second particles having different colors and different charge polarities,

the first particles and the second particles electrophoretically moving independently from each other when a first voltage potential difference is applied between the pair of electrodes,

the first particles and the second particles electrophoretically moving while forming a positively or negatively charged flocculation when a second voltage potential difference that is smaller than the first voltage potential difference is applied between the pair of electrodes, and

the display device performing voltage application including:

applying the first voltage potential difference to the pair of electrodes at which the first particles and the second particles electrophoretically move independently from each other and are attracted to either one of the pair of electrodes depending on the charge polarity of the first particles and the second particles, respectively; and

applying the second voltage potential difference to the pair of electrodes at which the first particles and the second particles electrophoretically move while forming a positively or negatively charged flocculation, and the flocculation is attracted to either one of the pair of electrodes depending on the charge polarity of the flocculation.

Hereinafter, exemplary embodiments of the invention will be described with reference to the drawings. Members having the same functions are designated by the same reference numerals throughout the drawings, and overlapping descriptions may be omitted in some cases. For the purpose of simplification, the exemplary embodiments are described as a single cell, as appropriate.

Particles having a cyan color are referred to as cyan particles C, particles having a magenta color are referred to as magenta particles M, and particles having a yellow color are referred to as yellow particles Y, and each particle and a group of particles are expressed by the same reference character.

The flocculation formed from particles of different kinds may be expressed by a combination of the reference characters of the particles that form the flocculation. For example, a flocculation of the cyan particles C and the magenta particles M may be referred to as a flocculation CM. Similarly, flocculations of other combinations may be referred to as a flocculation CY, a flocculation MY, a flocculation CMY, and the like.

### First Exemplary Embodiment

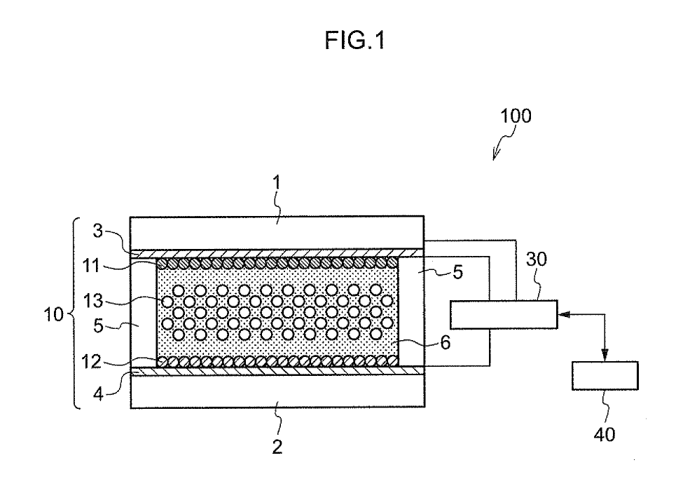

FIG. 1 schematically shows a display device according to a first exemplary embodiment of the invention. A display device 100 includes a display medium 10 and a voltage control unit (including a voltage application unit 30 and a control unit 40) that applies a voltage between a pair of electrodes 3 and 4 of the display medium 10.

In the display medium 10, a display substrate 1 on which an image is displayed and a rear substrate 2 on which an image is not displayed are disposed so as to face each other via a gap.

A gap member 5 maintains a gap between the substrates 1 and 2, and divides the substrates into plural cells.

The cell refers to a region surrounded by the rear substrate provided with a rear electrode 4, the display substrate 1 provided with a display side electrode 3, and the gap members 5. The cell contains a dispersion medium 6, first particles 11, second particles 12, and white particles 13, and these particles are dispersed in the dispersion medium 6.

The first particles 11 and the second particles 12 have different colors and charge polarities from each other. When a first potential difference is applied according to a voltage applied between the pair of electrodes 3 and 4, the first particles 11 and the second particles 12 move independently from each other, and when a second potential difference, which is smaller than the first potential difference, is applied, the first particles 11 and the second particles 12 form a positively or negatively charged flocculation. In contrast, the white particles 13, having a smaller charge amount than that of the first particles 11 and the second particles 12, do not move toward the electrode even when a voltage at which the first particles 11, the second particles 12, or a flocculation thereof move to the electrode is applied between the electrodes.

First, the members that constitute the display device according to this exemplary embodiment will be specifically described.

—Display Substrate and Rear Substrate—

The display substrate 1, or both the display substrate and the rear substrate, have translucency.

The display substrate 1 is provided with the display side electrode 3, and the rear substrate 2 is provided with the rear electrode 4.

Examples of the material for the display substrate 1 and the rear substrate 2 include glass and plastics such as a polyethylene terephthalate resin, a polycarbonate resin, an acrylic resin, a polyimide resin, a polyester resin, an epoxy resin, and a polyethersulfone resin.

The thickness of the display substrate 1 and the rear substrate 2 is from 50 μm to 3 mm, for example.

The display side electrode 3 and the rear electrode 4 may be formed from an oxide of indium, tin, cadmium, antimony or the like, a complex oxide such as ITO, a metal such as gold, silver, copper or nickel, or an organic material such as polypyrrole or polythiophene. The electrode may be formed as a single layer film, a mixed film or a composite film, and may be formed by a vapor deposition method, a sputtering method, a coating method, or the like.

When the electrode is formed by a vapor deposition method or a sputtering method, the thickness of the electrode is typically from 100 Å to 2000 Å. The rear electrode 4 and the display side electrode 3 may be formed into a predetermined pattern, such as a matrix pattern or a stripe pattern that allows passive matrix driving, by a known method such as etching that is performed in producing liquid crystal display media or printed circuit boards.

The display side electrode 3 may be embedded in the display substrate 1, and the rear electrode 4 may be embedded in the rear substrate 2.

In order to achieve active-matrix driving, each pixel may be provided with a TFT (thin film transistor). For ease of layering wirings or mounting members, the TFT is preferably formed on the rear substrate 2, rather than on the display substrate 1.

—Gap Member—

The gap member 5 that maintains the gap between the display substrate 1 and the rear substrate 2 is formed so as not to deteriorate the translucency of the display substrate 1, and is formed from, for example, a thermoplastic resin, a thermosetting resin, an electron beam-curable resin, a photo-curable resin, rubber, or a metal.

The gap member 5 may be integrated with either one of the display substrate 1 and the rear substrate 2. In this case, the gap member is produced by subjecting the substrate to etching, laser processing, or press processing in which a mold previously prepared is used, or printing.

The gap member 5 is formed on one or both of the rear substrate and the display substrate.

The gap member 5 may be colored or colorless, but is preferably colorless and transparent so as not to adversely affect the image displayed on the display medium. For example, a transparent resin, such as polystyrene, polyester or acrylic resin, may be used.

When a gap member having a particle shape or a spherical shape is employed, it is also preferably transparent, and particles of transparent resin, such as polystyrene, polyester, or acrylic resin, or glass particles may be used for the gap member.

In this exemplary embodiment, being “transparent” of having “translucency” refers to having a transmittance with respect to visible light of 60% or more.

—Dispersion Medium—

The dispersion medium 6 in which the electrophoretic particles are dispersed is preferably an insulating liquid. In the present specification, being “insulating” refers to having a volume resistivity of 10¹¹ Ωcm or more.

Specific preferable examples of the insulating liquid include hexane, cyclohexane, toluene, xylene, decane, hexadecane, kerosene, paraffin, isoparaffin, silicone oil, dichloroethylene, trichloroethylene, perchlorethylene, high purity oil, ethylene glycol, alcohols, ethers, esters, dimethylformamide, dimethylacetamide, dimethylsulfoxide, N-methylpyrrolidone, 2-pyrrolidone, N-methylformamide, acetonitrile, tetrahydrofuran, propylenecarbonate, ethylenecarbonate, benzine, diisopropylnaphthalene, olive oil, isopropanol, trichlorotrifluoroethane, tetrachloroethane, dibromotetrafluoroethane, and mixtures thereof. Among the above, silicone oil is preferably employed.

By removing impurities in order to satisfy the following volume resistance, water (i.e., pure water) is also preferably used as the dispersion medium. The volume resistance is preferably 10³ Ωcm or more, more preferably from 10⁷ Ωcm to 10¹⁹ Ωcm, and still more preferably from 10¹⁰ Ωcm to 10¹⁹ Ωcm.

The insulating liquid may include acids, alkalis, salts, dispersion stabilizers, stabilizers for preventing oxidation, absorbing ultraviolet radiation and the like, antimicrobial agents, antiseptics, and the like, as necessary. These substances are preferably added in such a manner that the volume resistance is within the above range.

Moreover, the insulating liquid may include, as a charge control agent, anionic surfactants, cationic surfactants, amphoteric surfactants, nonionic surfactants, fluorine-containing surfactants, silicone-containing surfactants, metal soap, alkyl phosphoric acid esters, succinimides and the like.

More specific examples of the ionic and nonionic surfactants include the following substances. Examples of the nonionic surfactants include polyoxyethylene nonylphenyl ether, polyoxyethylene octylphenyl ether, polyoxyethylene dodecylphenyl ether, polyoxyethylene alkyl ether, polyoxyethylene fatty acid ester, sorbitan fatty acid ester, polyoxyethylene sorbitan fatty acid ester, and fatty acid alkylol amide. Examples of the anionic surfactants include alkyl benzene sulfonates, alkyl phenyl sulfonates, alkyl naphthalene sulfonates, higher fatty acid salts, sulfuric acid salts of higher fatty acid esters, and sulfonic acid salts of higher fatty acid esters. Examples of the cationic surfactants include primary to tertiary amine salts and quaternary ammonium salts.

The amount of the charge control agent is preferably in the range of from 0.01% by weight to 20%© by weight, and particularly preferably from 0.05% by weight to 10%© by weight, with respect to the solid content of the particles.

As the dispersion medium 6, polymer resins may be used together with the insulating liquid. The polymer resins are also preferably polymer gels, high molecular weight polymers, etc.

Specific examples of the polymer resins include polymer gels derived from naturally-occurring polymers, such as agarose, agaropectin, amylase, sodium alginate, propylene glycol alginate, isolichenan, insulin, ethyl cellulose, ethyl hydroxyethyl cellulose, curdlan, casein, carragheenan, carboxymethylcellulose, carboxymethyl starch, callose, agar, chitin, chitosan, silk fibroin, guar gum, quince seed, Crown Gall polysaccharide, glycogen, glucomannan, keratan sulfate, keratin protein, collagen, cellulose acetate, gellan gum, schizophyllan, gelatin, ivory nut mannan, tunicin, dextran, dermatan sulfate, starch, tragacanth gum, nigeran, hyaluronic acid, hydroxyethylcellulose, hydroxypropylcellulose, pustulan, funoran, degraded xyloglucan, pectin, porphyran, methylcellulose, methyl starch, laminaran, lichenan, lentinan, and locust bean gum. Regarding synthetic polymers, almost all kinds of polymer gels are applicable.

Further examples include polymers containing a functional group of alcohol, ketone, ether, ester or amide in the repeating unit thereof, such as polyvinyl alcohol, poly(meth)acryl amide or derivatives thereof, polyvinyl pyrrolidone, polyethylene oxide, and copolymers including these polymers.

Among the above, gelatin, polyvinyl alcohol, poly(meth)acryl amide and the like are preferably used.

A colorant may be mixed with the dispersion medium so that the dispersion medium exhibits a color different from the color of the electrophoretic particles.

Examples of the colorants to be mixed with the dispersion medium include known colorants, such as carbon black, titanium oxide, magnesium oxide, zinc oxide, phthalocyanine copper-based cyan colorants, azo-based yellow colorants, azo-based magenta colorants, quinacridone-based magenta colorants, red colorants, green colorants, and blue colorants. Specific examples include aniline blue, calco oil blue, chrome yellow, ultra marine blue, Dupont oil red, quinoline yellow, methylene blue chloride, phthalocyanine blue, malachite green oxalate, lamp black, rose bengal, C. I. pigment red 48:1, C.I. pigment red 122, C.I. pigment red 57:1, C.I. pigment yellow 97, C.I. pigment blue 15:1, and C.I. pigment blue 15:3.

Considering that the electrophoretic particles 11 and 12 move in the dispersion medium, when the viscosity of the dispersion medium 6 is equal to or higher than a specific value, it may not be possible to obtain a threshold value for allowing the particles to move according to an electric field due to a large variation in forces applied to the rear substrate 2 and the display substrate 1. Accordingly, it is preferable to adjust the viscosity of the dispersion medium.

The viscosity of the dispersion medium 6 is preferably from 0.1 mPa·s to 100 mPa·s, more preferably from 0.1 mPa·s to 50 mPa·s, and still more preferably from 0.1 mPa·s to 20 mPa·s at a temperature of 20° C.

The viscosity of the dispersion medium can be adjusted by controlling the molecular weight, structure, composition or the like of the dispersion medium. The measurement of the viscosity can be performed by using a viscometer (B-8L, trade name, manufactured by Tokyo Keiki Inc.)

—Electrophoretic Particles—

In this exemplary embodiment, the electrophoretic particles include two or more kinds of particles including the first particles 11 and the second particles 12 having different colors and charge polarities from each other. According to a voltage applied between the pair of electrodes, the first particles 11 and the second particles 12 move independently from each other, or the first particles 11 and the second particles 12 move while forming a flocculation that is positively or negatively charged.

The flocculating force between the different kinds of particles may be controlled by, for example, attaching a polymer dispersing agent to the surface of the particles in order to control the flocculation properties of the particles. For example, when silicone oil is used as the dispersion medium and a polymer dispersing agent having compatibility with the silicone oil is attached to the surface of the particles, the polymer dispersing agent spreads in the dispersion medium. Accordingly, when both of the electrophoretic particles 11 and 12 have the polymer dispersing agent on the surface, the polymer dispersing agents on the particles repel each other, thereby making it difficult to form a flocculation.

The flocculating force among the different kinds of particles may be controlled by, for example, adjusting the charge amount of the particles. For example, when the two kinds of electrophoretic particles 11 and 12 have a large charge amount, these particles tend to form a flocculation by an electrostatic force.

The structure, production process or the like of the electrophoretic particles will be described later.

—White Particles—

The white particles may be formed from particles obtained by dispersing a white pigment, such as titanium oxide, silicon oxide or zinc oxide, in a medium such as polystyrene, polyethylene, polypropylene, polycarbonate, PMMA, an acrylic resin, a phenol resin, a formaldehyde condensate or the like. It is also possible to use polystyrene particles, polyvinyl naphthalene particles, or the like.

The means for fixing the display substrate 1 provided with the display side electrode 3 and the rear substrate 2 provided with the rear electrode 4 through the gap member 5 is not particularly limited, and may be a combination of a bolt and a nut, a clamp, a clip, a frame for fixing the substrate, or the like. It is also possible to use a fixing means such as adhesive, heat melting, ultrasonic junction or the like.

The display medium as described above may be used for clip boards for storing and re-writing images, notices for circulation, media boards, advertisements, signboards, blinking signs, electronic paper, electronic newspaper, digital books, and document sheets commonly used in copying machines and printers, etc.

—Voltage Application Unit and Control Unit—

When the voltage control unit (voltage application unit 30 and control unit 40) applies a first potential difference between the pair of electrodes 3 and 4 of the display medium 10, the particles 11 and 12 move independently from each other to each of the electrodes 11 and 12 according to the charge polarity of the particles. When the voltage control unit applies a second potential difference, which is smaller than that of the first potential difference, the particles 11 and 12 form a flocculation and this flocculation is attracted to one of the electrodes 11 and 12 according to the charge polarity of the flocculation.

In this way, it is possible to display four kinds of colors including a color of the particles 11, a color of the particles 12, a color of the flocculation of the particles 11 and 12, and a color of the white particles 13 that do not electrophoretically move in the dispersion medium 6.

The voltage application unit 30 is electrically connected to each of the display side electrode 3 and the rear electrode 4.

The voltage application unit 30 is connected to the control unit 40 so that signals are transferred and received therebetween.

The control unit 40 may be a microcomputer containing a CPU (central processing unit) that manages the operation of the entire device, an RAM (Random Access Memory) that temporarily memorizes various data, and an ROM (Read Only Memory) in which various programs, such as a control program for controlling the entire device, are previously stored.

The voltage application unit 30 is a voltage application device that applies a voltage to the display side electrode 3 and the rear electrode 4 according to the instructions from the control unit 40, and imparts a potential difference.

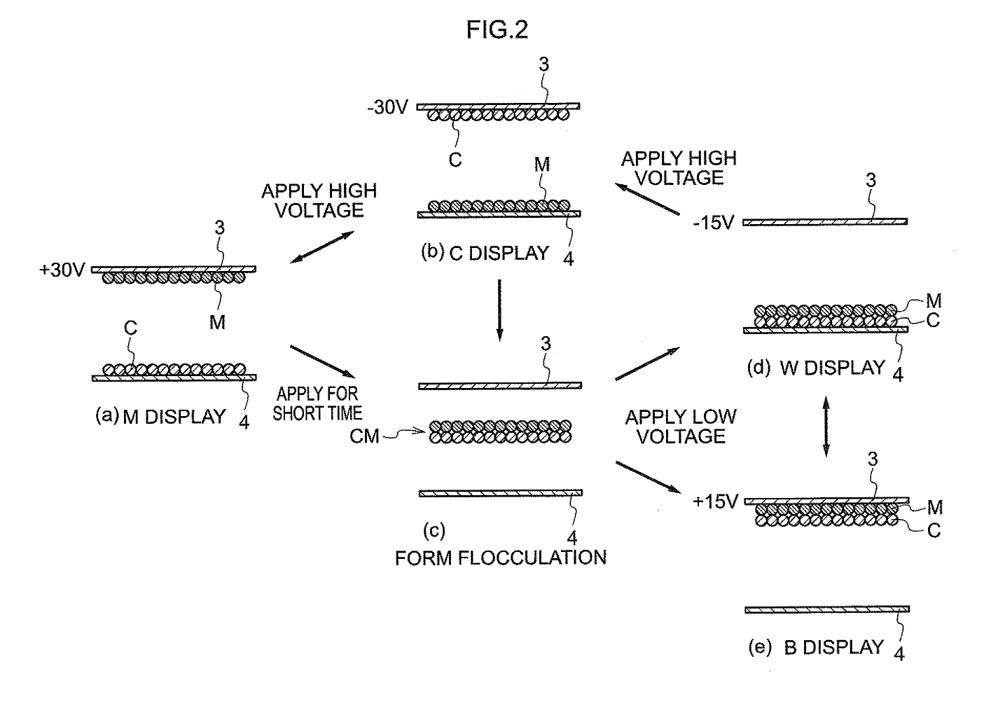

FIG. 2 schematically shows the behavior of the electrophoretic particles 11 and 12 in response to the voltage application in the display medium according to the first exemplary embodiment. In FIGS. 2 to 6, descriptions of the white particles 13, the dispersion medium 6, the substrates (display substrate 1 and rear substrate 2), the gap member 5 and the like are omitted.

In this exemplary embodiment, the first particles 11 are negatively charged electrophoretic particles having a magenta color (magenta particles M), the second particles 12 are positively charged electrophoretic particles having a cyan color (cyan particles C), and the flocculation as a whole is negatively charged. However, this exemplary embodiment is not limited to the above configuration, i.e., the color and the charge polarity of each kind of particles may be arbitrarily determined, and the flocculation as a whole may be positively charged. Further, the voltage to be applied is not limited to the following specific embodiments, and may be determined as appropriate according to the charge polarity or responsibility of the particles, or the distance between the electrodes, etc.

—Magenta Color Display—

As shown in (a) in FIG. 2, when a voltage of 30 V is applied such that the electrode 3 at the display side is positive, the negatively charged magenta particles M move to the display side electrode 3 and the positively charged cyan particles C move to the rear electrode 4, and these particles are attached to the entire surface of each electrode. As a result, a magenta color of the magenta particles is displayed (M display) through the display side electrode 3 and the display substrate 1.

—Cyan Color Display—

In contrast, as shown in (b) in FIG. 2, when a voltage of 30 V is applied such that the electrode 3 at the display side is negative, the negatively charged cyan particles C move to the display side electrode 3 and the positively charged magenta particles C move to the rear electrode 4, and these particles are attached to the entire surface of each electrode. As a result, a cyan color of the cyan particles is displayed (C display) through the display side electrode 3 and the display substrate 1.

—White Color Display—

As shown in (c) in FIG. 2, when a voltage is applied to the display device displaying a magenta color such that the voltage is turned off (0 V) within a time period shorter than Tmc (a time period during which the displayed color is changed from magenta to cyan by inverting the polarity of the voltage applied to the electrodes 3 and 4), the particles of each kind move away from one electrode toward the opposite electrode, and form a flocculation (flocculation CM) while these particles are moving. Alternatively, given that the time period during which the displayed color is changed from cyan to magenta is determined as Tcm, a flocculation may be formed by applying a voltage to the display device displaying a cyan color for a time period shorter than Tcm.

The flocculation as a whole is either negatively or positively charged depending on the degree of polarity or the amount of the particles C and the particles M that form the flocculation. In this exemplary embodiment, the flocculation is negatively charged, but it may be positively charged.

As shown in (d) in FIG. 2, when a voltage that is low enough to allow the flocculation CM to move as it is without separating into the particles C and the particles M is applied, for example, a voltage of 15 V is applied such that the display side electrode 3 is negative, the negatively charged flocculation moves to the rear electrode 4 and is attached thereto. At this time, when viewed from the display side substrate, a white color of the white particles (not shown in FIG. 2) dispersed in the dispersion medium without electrophoretically moving is displayed (W display). The white color may be displayed by using a dispersion medium having a white color instead of using the white particles.

When a higher voltage at which the flocculation decomposes into the particles C and the particles M is applied to the display medium displaying a white color, for example, when a voltage of 30 V is applied such that the display side electrode 3 is positive, the displayed color is changed to a magenta color (M display).

—Blue Display—

When a flocculation is formed after displaying a magenta color or a cyan color, and then, for example, a voltage of 15 V is applied such that the display side electrode 3 is positive, the negatively charged flocculation CM moves to the display side electrode 3 and is attached thereto, as shown in (e) in FIG. 2. At this time, a blue color derived from the flocculation CM is displayed (B display).

It is also possible to change the displayed color from white to blue by applying a voltage such that the polarities of the electrodes are in an opposite manner to the above.

When a voltage at which the aggregate CM decomposes into the particles C and the particles M is applied to the display medium displaying a white color, for example, when a voltage of 30 V is applied such that the display side electrode 3 is negative, the cyan particles C are attracted to the display side electrode 3 and the magenta particles M are attracted to the rear electrode side, thereby changing the displayed color from white to cyan (C display).

As described above, by using two kinds of particles that move not only in an independent manner from each other but also in the form of a flocculation thereof upon application of a predetermined level of voltage, four kinds of colors can be displayed by controlling the level of the voltage to be applied to the electrodes 3 and 4, or the time for applying the voltage.

Next, a display medium in which three kinds of electrophoretic particles are used is described. The electrophoretic particles include, in addition to the first and second particles, third particles that at least can move independently in response to a voltage applied between a pair of electrodes, and have an flocculating force with respect to the first particles and/or the second particles that is different from the flocculating force of the flocculation of the first particles and the second particles.

By including the third particles, a wider variety of colors can be displayed by applying a voltage at which a flocculation is formed by the third particles and the first particles or the second particles, and is attracted to one of the pair of electrodes depending on the charge polarity of the flocculation; or applying a voltage at which a flocculation is formed by the third particles, the first particles and the second particles, and is attracted to one of the pair of electrodes depending on the charge polarity of the flocculation.

### Second Exemplary Embodiment

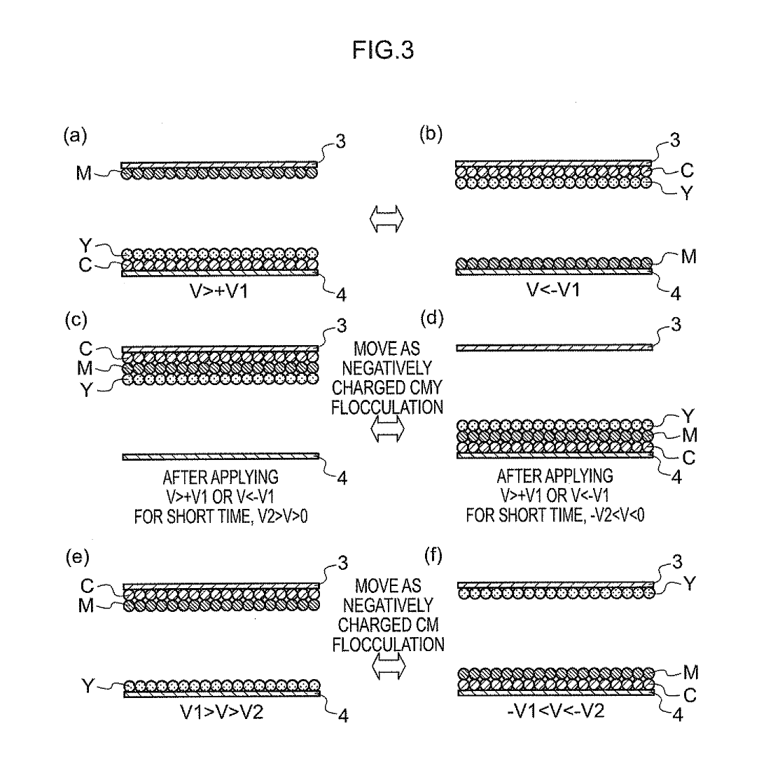

FIG. 3 schematically shows a display medium that constitutes a display device according to a second exemplary embodiment.

In this display medium, positively charged yellow particles Y are dispersed as electrophoretic particles in a dispersion medium, in addition to the positively charged cyan particles C and the negatively charged magenta particles M.

According to the level of electric field intensity, a flocculation is formed by the cyan particles C, the magenta particles M and the yellow particles Y; the cyan particles C and the magenta particles M; or the magenta particles M and the yellow particles Y, mainly due to an electrostatic attraction force. The flocculation of each type as a whole is negatively charged. The charge polarities of the particles C, M and Y are adjusted such that the flocculating force of the magenta particles M and the cyan particles C (CM flocculating force) is greater than the flocculating force of the magenta particles M and the yellow particles Y (MY flocculating force), i.e., CM aggregating force>MY aggregating force. Accordingly, when a voltage required at least for the separation of the cyan particles C and the magenta particles M that are forming a flocculation (referred to as “CM separation”) is defined as V1, and a voltage required at least for the separation of the aggregated magenta particles M and the yellow particles Y that are forming a flocculation (referred to as “MY separation”) is defined as V2, the relationship V1>V2 is satisfied.

In this exemplary embodiment, two kinds of positively charged particles (cyan particles C and yellow particles Y) and one kind of negatively charged particles (magenta particles M) are used, but it is also possible to use one kind of positively charged particles and two kinds of negatively charged particles. The combination of the color and the charge polarity of the particles may be determined as appropriate, and the flocculation of each type as a whole may be positively charged. Moreover, the relationship among the flocculating force is not limited to the above, and may satisfy CM aggregating force<MY aggregating force.

—Magenta Color Display and Green Color Display—

When a voltage V, which satisfies the relationship V>V1, is applied between the electrodes such that the display side electrode 3 is positive and the rear electrode 4 is negative, the negatively charged magenta particles M are attracted to the display side electrode 3 and the positively charged cyan particles C and yellow particles Y are attracted to the rear electrode 4, thereby displaying a magenta color ((a) in FIG. 3).

In contrast, when a voltage V, which satisfies the relationship |V|>|V1|, is applied between the electrodes such that the display side electrode 3 is negative and the rear electrode 4 is positive, the positively charged cyan particles C and yellow particles Y are attracted to the display side electrode 3 and the negatively charged magenta particles M are attracted to the rear electrode 4, thereby displaying a green color formed from a cyan particle layer and a yellow particle layer ((b) in FIG. 3).

It is also possible to change the displayed color from green to magenta by applying a voltage that satisfies the relationship |V|>|V1| to the electrodes such that the display side electrode is positive and the rear electrode is negative.

—Black Color Display and White Color Display—

A voltage V that satisfies the relationship V<−V1. is applied to the display medium being in a state of (a) in FIG. 3 (magenta color display) for a short period of time such that the display side electrode 3 is negative and the rear electrode 4 is positive. At this time, the voltage is turned off (0 V) before the particles C, M and Y that have been attracted to either one of the electrodes 3 and 4 move away from the electrode and reach the other electrode. At this time, the three kinds of electrophoretic particles form a flocculation (flocculation CMY) that is as a whole negatively charged, at a position away from the electrodes 3 and 4. Subsequently, when a voltage V that satisfies the relationship |V2|>|V| is applied, the particles move according to the potential difference of the electrodes, while maintaining the formation of flocculation CMY.

For example, when a voltage V having the intensity mentioned above is applied such that the display side electrode 3 is positive and the rear electrode 4 is negative, the flocculation CMY is attracted to the display side electrode 3 and a black color is displayed ((c) in FIG. 3). When a voltage V (−V2<V<0) is applied such that the display side electrode 3 is negative and the rear electrode 4 is positive, the flocculation CMY is attracted to the rear electrode 4, and a white color of the white particles that do not electrophoretically move in the dispersion medium is displayed ((d) in FIG. 3). It is also possible to display a white color by using a dispersion medium having a white color instead of using white particles, also in this exemplary embodiment.

It is also possible to apply a voltage V that satisfies V>+V1 to the display medium being in a state of (b) in FIG. 3 for a short period of time such that the display side electrode 3 is positive and the rear electrode 4 is negative in order to allow the three kinds of particles to move away from the electrodes and form a flocculation CMY, and subsequently apply a voltage that satisfies |V2|>|V|. In this case, the flocculation CMY moves as it is, and black color display ((c) in FIG. 3) or white color display ((d) in FIG. 3) may be achieved according to the potential difference of the electrodes 3 and 4.

Further, it is also possible to change the displayed color from block to white, or from white to black, by applying a voltage V that satisfies |V2|>|V| such that the polarities of the electrodes are in an opposite manner to the above.

—Blue Display and Yellow Display—

When a voltage V that satisfies V1>V>V2 is applied to the display medium being in a state of (c) in FIG. 3 (displaying a black color) such that the display side electrode 3 is positive and the rear electrode 4 is negative, the magenta particles M and the yellow particles Y are separated, while the cyan particles C and the magenta particles M remain in the state of flocculation. As a result, only the yellow particles Y are attracted to the rear electrode 4, and a blue color of a flocculation CM (negatively charged) of the cyan particles C and the magenta particles M is displayed ((e) in FIG. 3).

In contrast, when a voltage V that satisfies −V1>V>−V2 is applied to the display medium being in the state of (d) in FIG. 3 (displaying a white color) such that the display side electrode 3 is negative and the rear electrode 4 is positive, the yellow particles Y are separated while the cyan particles C and the magenta particles M remain in the state of flocculation. As a result, only the yellow particles Y move to the display side electrode 3, and a yellow color of the yellow particles Y is displayed ((f) in FIG. 3).

It is also possible to change the displayed color from blue to yellow, or from yellow to blue, by applying a voltage that satisfies |V1|>|V|>|V2| such that the polarities of the electrodes are in an opposite manner to the above.

As described above, when a flocculation is formed from electrophoretic particles, and the electrophoretic particles include three kinds of particles having different flocculating forces, six colors can be displayed by utilizing the difference in the flocculating forces by controlling the intensity of the voltage applied between the electrodes or the time for applying the voltage.

### Third Exemplary Embodiment

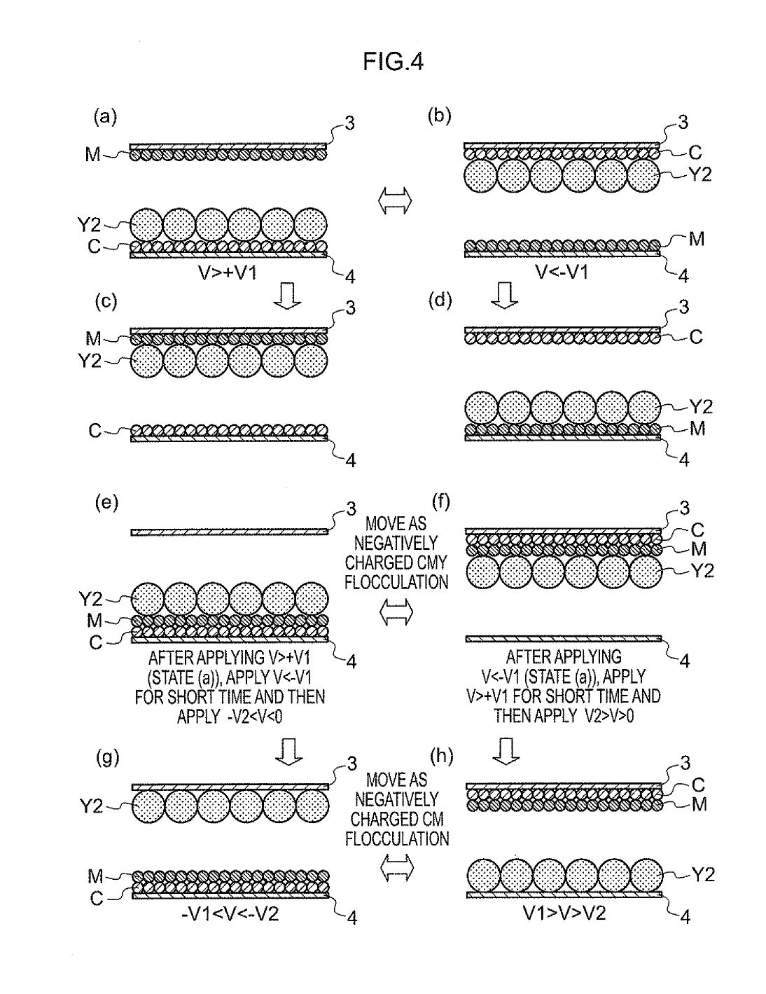

FIG. 4 schematically shows a display medium that constitutes a display device according to a third exemplary embodiment.

In this display medium, positively charged cyan particles C, negatively charged magenta particles M, and positively charged yellow particles Y2 having a particle diameter larger than that of the cyan particles C and the magenta particles M are dispersed as electrophoretic particles in a dispersion medium. The size of the particles may be determined such that the cyan particles C and the magenta particles M can move through the yellow particles Y2. The large yellow particles Y2 have a higher responsiveness to a voltage applied between the electrodes than that of the cyan particles C and the magenta particles M having a small diameter. The particle diameter of the yellow particles Y2 is preferably at least 10 times as large as the particle diameter of the cyan particles C and the magenta particles M from the viewpoint that the responsiveness to a voltage (potential) is higher than that of the cyan particles C and the magenta particles M, and that the cyan particles C and the magenta particles M can readily move through the yellow particles Y2. The relationships among the flocculations or the flocculating forces of the particles are the same as that of the second exemplary embodiment.

In the present specification, the particle diameter refers to a volume average particle diameter of particles, and is a value measured by a laser diffraction particles diameter analyzer (Horiba LA-300, trade name, manufactured by Horiba Ltd.)

—Magenta Color Display and Green Color Display—

The magenta color display and the green display are the same as those of the second exemplary embodiment. Namely, when a voltage V that satisfies |V|>|V1| is applied between the electrodes, flocculation of particles of different kinds does not occur, and a magenta color is displayed when the display side electrode 3 is positive since the magenta particles M are attracted thereto ((a) in FIG. 4), while a green color is displayed when the display side electrode 3 is negative since the cyan particles C and the yellow particles Y2 are attracted thereto ((b) in FIG. 4). In particular, by using the large diameter yellow particles Y2 in this exemplary embodiment, a layer of the cyan particles C and a layer of the yellow particles Y2 are formed.

—Red Color Display and Cyan Color Display—

A short-time pulse voltage is applied to a display medium being in a state (a) shown in FIG. 4 (displaying a magenta color) or in a state (b) shown in FIG. 4 (displaying a green color) such that the large diameter yellow particles Y2 respond to the voltage but the cyan particles C and the magenta particles M do not respond to the voltage but, and only the large diameter yellow particles Y2 are moved to the opposite electrode. Therefore, only the yellow particles Y2 move and a red color derived from the magenta particles and the yellow particles Y2 is displayed ((c) in FIG. 4) or a cyan color is displayed by the cyan particles C ((d) in FIG. 4).

The method of applying a voltage for moving only the yellow particles Y2 may be a method in which the yellow particles Y2 are driven at (voltage)×(time) to which the cyan particles C and the magenta particles M do not respond.

From the viewpoint of driving force/charge amount, it is important that the yellow particles Y2 are larger enough than the cyan particles C and the magenta particles M, and from the viewpoint of forming layers of the cyan particles C and the yellow particles Y2, it is important that the cyan particles C can move through the yellow particles such that a layer of the cyan particles and a layer of the yellow particle layer are formed. According to the experiments conducted by the present inventors, the particle diameter of the yellow particles Y2 needs to be at least 10 times as large as that of the cyan particles C.

Moreover, according to the experiments conducted the present inventors, it takes about 0.1 seconds for particles having a diameter of 500 nm or less to start moving away from the electrode at an electric field intensity of 0.3 V/μm, while particles having a diameter of 5 μm or greater move from one electrode to the other electrode during the same period of time.

—White Color Display and Black Color Display—

The process for displaying a white color or a black color is basically the same as that of the second exemplary embodiment. When a voltage that satisfies |V|>|V1| is applied to a display medium being in a state (a) shown in FIG. 4 (displaying a magenta color) or in a state (b) in FIG. 4 (displaying a green color) for a short period of time in order to allow the cyan particles C and the magenta particles M to move away from the electrodes, and a low voltage (voltage at which a flocculation of the yellow particles Y2 and the magenta particles M does not decompose: |V2|>|V|) is applied in order to move the cyan particles C, the magenta particles M and the yellow particles Y2, a flocculation CMY is formed from these three kinds of electrophoretic particles. After the formation of the flocculation CMY, a white color or a black color can be displayed by moving the flocculation CMY either to the side of display side electrode 3 or to the rear electrode 4 by applying a voltage that satisfies |V2|>|V|.

For example, after forming a flocculation CMY of three kinds of particles at a position away from the electrodes by applying a voltage that satisfies V<−V1 to the electrodes of the display medium displaying a magenta color for a short period of time such that the display side electrode 3 is negative and the rear electrode 4 is positive, a voltage V that satisfies −V2<V<0 is applied such that the display side electrode 3 is negative and the rear electrode 4 is positive. As a result, the three kinds of electrophoretic particles move to the rear electrode 4 as a negatively charged flocculation CMY, and a white color of the white particles that are dispersed in a dispersion medium but do not electrophoretically move, or of a dispersion medium having a white color, is displayed ((e) in FIG. 4).

In order to suppress the mixing of colors, the yellow particles Y2 preferably form a top layer. When both the cyan particles C and the magenta particles M have a particle diameter that allows these particles to move through the particles of the yellow particles Y2, a layered structure in which the yellow particles Y2 form a top layer can be obtained.

On the other hand, after forming a flocculation CMY of three kinds of particles at a position away from the electrodes by applying a voltage V that satisfies V>V1 to the electrodes of the display medium displaying a green color for a short period of time such that the display side electrode 3 is positive and the rear electrode 4 is negative, a voltage V that satisfies V2>V>0 is applied such that the display side electrode 3 is positive and the rear electrode 4 is negative. As a result, the three kinds of electrophoretic particles move to the display side electrode 3 as a negatively charged flocculation CMY, thereby displaying a black color ((f) in FIG. 4).

It is also possible to change the displayed color from black to white, or from white to black, by applying a voltage that satisfies |V2|>|V| to the electrodes such that the polarities of the electrodes are in an opposite manner to the above.

—Blue Color Display and Yellow Color Display—

When a voltage V that satisfies −V1<V<−V2 is applied to the display medium being in a state (e) in FIG. 4 (displaying a white color) such that the display side electrode 3 is negative and the rear electrode 4 is positive, the yellow particles Y2 separate from a flocculation and move to the display side electrode 3, while the cyan particles C and the magenta particles M remain in a state of being attached to the rear electrode 4 as a negatively charged aggregate CM. As a result, a yellow color of the yellow particles Y2 is displayed.

On the other hand, when a voltage V that satisfies V1>V>V2 is applied to the display medium being in a state (f) in FIG. 4 (displaying a black color) such that the display side electrode 3 is positive and the rear electrode 4 is negative, the yellow particles Y2 separate from a flocculation and move to the rear electrode 4, while the cyan particles C and the magenta particles M remain in a state of being attached to the display side electrode 4 as a negatively charged aggregate CM. As a result, a blue color of the flocculation CM formed from the cyan particles C and the magenta particles M is displayed.

It is also possible to change the displayed color from blue to yellow, or from yellow to blue, by applying a voltage that satisfies |V1|>|V|>|V2| such that the polarities of the electrodes are in an opposite manner to the above.

As described above, by using three kinds of electrophoretic particles that form a flocculation, including two kinds of particles having a smaller particle diameter and one kind of particles having a larger particle diameter whose responsiveness is higher than that of the small particles, eight colors can be displayed by utilizing the differences in the flocculating force and the responsiveness of these particles, and controlling the intensity of the voltage to be applied between the electrodes or the time for applying the voltage.

### Fourth Exemplary Embodiment

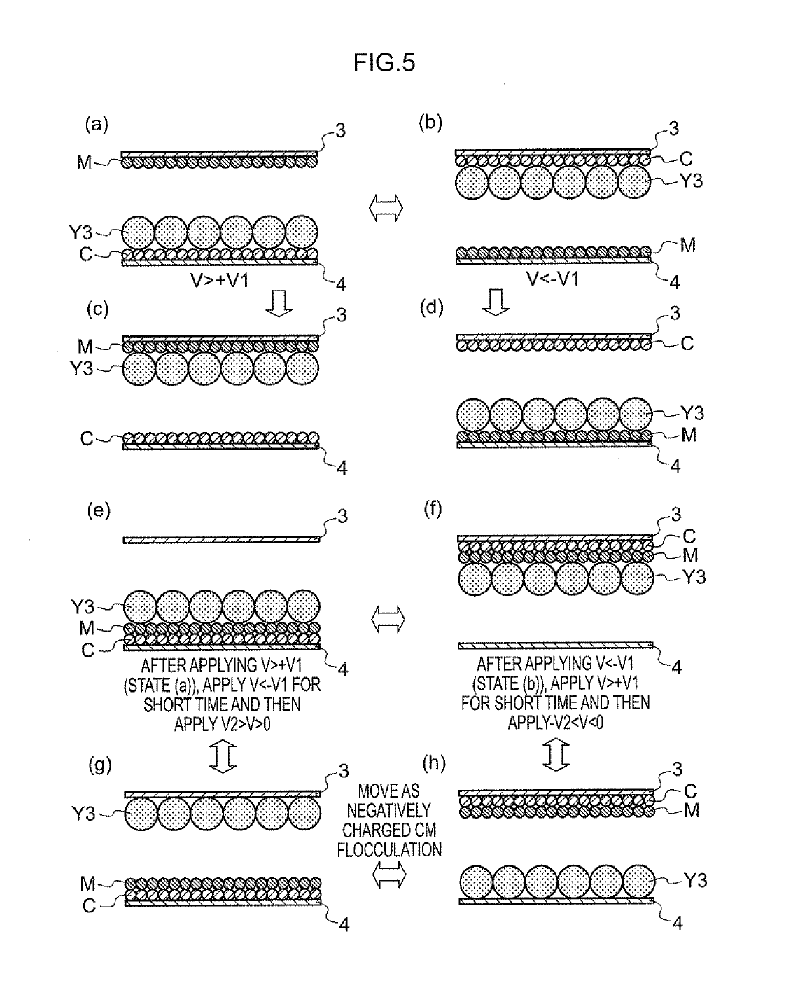

FIG. 5 schematically shows a display medium that constitutes a display device according to a fourth exemplary embodiment.

In this display medium, positively charged cyan particles C, negatively charged magenta particles M, and positively charged yellow particles Y3 having a particle diameter larger than that of the cyan particles C and the magenta particles M are dispersed as electrophoretic particles in a dispersion medium. The cyan particles C and the magenta particles M can form a flocculation with each other. The yellow particles Y3 do not have an ability of forming a flocculation with particles of a different kind, or have an extremely small ability of forming a flocculation as compared with that of the cyan particles C and the magenta particles M and do not form a flocculation with the cyan particles C or the magenta particles M.

The flocculating forces of the cyan particles C and the magenta particles M are the same as that of the third exemplary embodiment, and a voltage of at least V1 is required for separating the cyan particles C and the magenta particles M that are forming a flocculation (flocculation CM).

—Magenta Color Display and Green Color Display—

A voltage to be applied for performing magenta color display and green color display is the same as that of the third exemplary embodiment. More specifically, when a voltage is applied such that the display side electrode 3 is negative and the rear electrode 4 is positive, the magenta particles M are attracted to the display side electrode 3 and a magenta color is displayed ((a) in FIG. 5). When the display side electrode 3 is negative, the cyan particles C and the yellow particles Y3 are attracted to the display side electrode and a green color is displayed ((b) in FIG. 5).

—Red Color Display and Cyan Color Display—

The display color is changed from magenta ((a) in FIG. 5) to red ((c) in FIG. 5) or from green ((b) in FIG. 5) to cyan ((d) in FIG. 5) basically in the same manner as that of the third exemplary embodiment. Namely, by applying a pulse voltage, to which only the large yellow particles Y3 respond but the cyan particles C and the magenta particles M do not, for a short period of time to the display medium being in a state of (a) in FIG. 5 (magenta color display) or in a state of (b) in FIG. 5 (green color display), only the large yellow particles Y3 are moved to the opposite electrode. As a result, a red color from the magenta particles M and the yellow particles Y3 is displayed ((c) in FIG. 5) or a cyan color from the cyan particles C is displayed ((d) in FIG. 5). Since the yellow particles Y3 do not form a flocculation with a different kind of particles, the yellow particles Y3 separate more easily and move to the rear electrode 4 at a lower voltage within a shorter period of time, as compared with the case of the third exemplary embodiment.

—White Color Display and Black Color Display—

After applying a voltage V that satisfies |V|>|V1| for a short period of time to the display medium being in a state of (a) in FIG. 5 (magenta color display) or in a state of (b) in FIG. 5 (green color display) in order to allow the particles C, M and Y3 to move away from the electrodes 3 and 4, a voltage V that satisfies |V1|>|V| is applied. As a result, a flocculation CM of the cyan particles C and the magenta particles M is formed. When the aggregate CM and the yellow particles Y3 have the same polarity, the aggregate CM and the yellow particles Y3 move to the same electrode according to the polarity of the electrodes 3 and 4. As a result, a white color ((e) in FIG. 5) or a black color ((f) in FIG. 5) is displayed.

—Blue Color Display and Yellow Color Display—

A pulse voltage to which the large diameter yellow particles Y3 respond but the flocculation of the cyan particles C and the magenta particles M does not is applied to the display medium being in a state of (e) in FIG. 5 (black color display) or in a state of (f) in FIG. 5 for a short period of time. In this case, the large diameter yellow particles Y3 are moved at a (voltage)×(time) to which the cyan particles C and the magenta particles M do not respond. It is important that the yellow particles Y3 are larger enough as compared with the cyan particles C and the magenta particles M, and that the cyan particles C and the magenta particles M can move through the yellow particles and form a layer of the cyan particles C, a layer of the magenta particles M and a layer of the yellow particles Y3, respectively. According to the experiments conducted by the present inventors, the particle diameter of the yellow particles Y3 is required to be at least 10 times as large as that of the cyan particles C and the magenta particles M.

By moving only the yellow particles Y3 to the opposite electrode, a yellow color ((g) in FIG. 5) or a blue color ((h) in FIG. 5) is displayed.

When the flocculation CM and the yellow particles Y3 have the opposite polarities to each other, the flocculation CM and the yellow particles Y3 move to the electrode different from each other. Thus, according to the polarity of each of the electrodes 3 and 4, a yellow color ((g) in FIG. 5) or a blue color derived from the flocculation CM ((h) in FIG. 5) is displayed.

Further, by applying a short-time pulse voltage to which the large yellow particles Y3 respond but the flocculation of the cyan particles C and the magenta particles M does not to the display medium being in a state of (g) in FIG. 5 (yellow color display) or in a state of (h) in FIG. 5 (blue color display), only the large diameter yellow particles Y3 move to the opposite electrode, thereby displaying a white color ((e) in FIG. 5) or a black color ((f) in FIG. 5).

As described above, by using three kinds of electrophoretic particles including two kinds of particles having a small diameter that form a flocculation and one kind of particles having a large diameter whose responsiveness is higher than that of the small diameter particles, eight colors can be displayed by utilizing differences in the flocculating force or differences in responsiveness among these particles, and controlling the intensity of the voltage to be applied between electrodes and the time for applying the a voltage.

### Fifth Exemplary Embodiment

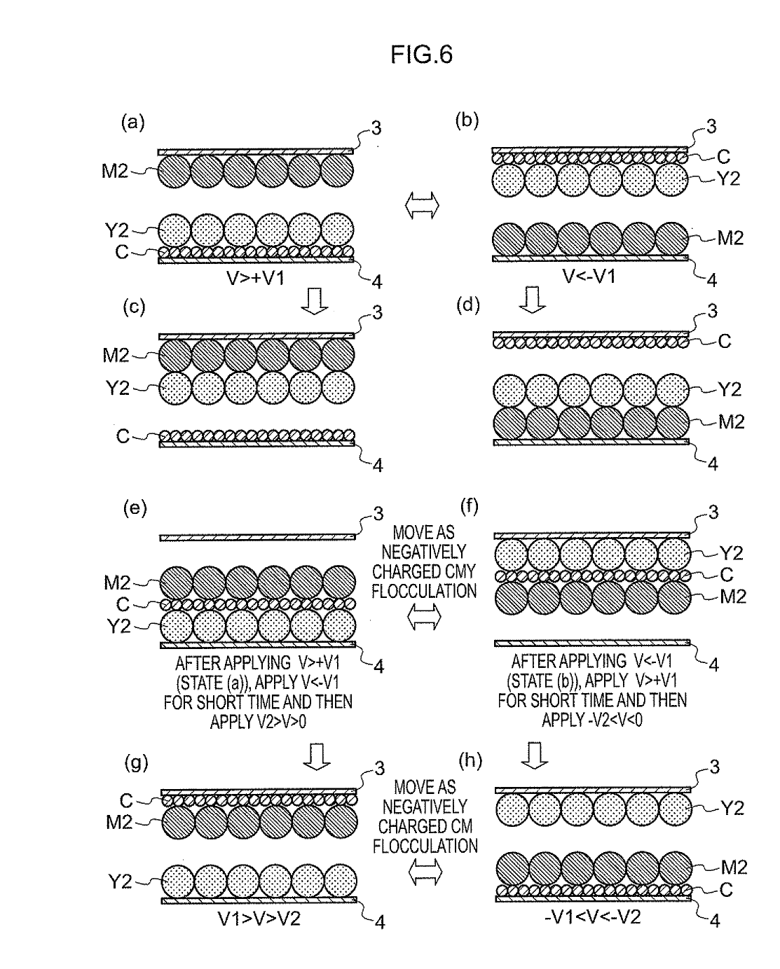

FIG. 6 schematically shows a display medium that constitutes a display device according to a fifth exemplary embodiment.

In this display medium, positively charged cyan particles C, positively charged yellow particles Y2 having a particle diameter larger than that of the cyan particles C and a responsiveness higher than that of the cyan particles C, and negatively charged magenta particles M having a particle diameter larger than that of the cyan particles C and a responsiveness higher than that of the cyan particles C are dispersed as electrophoretic particles in a dispersion medium. These three kinds of electrophoretic particles form a flocculation according to a voltage applied between the electrodes. The cyan particles C and the magenta particles M form a flocculation, and the magenta particles M and the yellow particles Y2 form a flocculation. The charge polarities of these particles are adjusted such that the flocculating force of the magenta particles M and the cyan particles C (CM flocculating force) is larger than the flocculating force of the magenta particles M and the yellow particles Y2 (MY flocculating force) (CM flocculating force>MY flocculating force). Accordingly, the voltage V1, which is required at least for separating the cyan particles C and magenta particles M that are forming a flocculation, and the voltage V2, which is required at least for separating the magenta particles M and yellow particles Y2 that are forming a flocculation, satisfy the relationship V1>V2.

The three kinds of electrophoretic particles may include two kinds of particles that can form a flocculation together and one kind of particles that do not form a flocculation with other kinds of particles.

—Magenta Color Display and Green Color Display—

When a voltage that satisfies |V|>|V1| is applied, a flocculation of different kinds of particles is not formed, and particles of each kind are attracted to the electrode 3 or 4 depending on the charge polarity and the polarity of the electrode, thereby displaying a magenta color ((a) in FIG. 6) or a green color ((b) in FIG. 6). By using the large yellow particles Y2, a layer of yellow particles Y2 and a layer of the cyan particles C are formed and a green color is displayed.

—Red Color Display and Cyan Color Display—

A short-time pulse electrode to which the large yellow particles Y2 respond but the cyan particles C and the magenta particles M do not is applied to the display medium being in a state of (a) in FIG. 6 (magenta color display) or in a state of (b) in FIG. 6 (green color display). At this time, the yellow particles Y2 are moved at a (voltage)×(time) to which the smaller cyan particles C and the magenta particles M do not respond. It is important that the yellow particles Y2 are larger enough as compared with the cyan particles C and, in particular, that the cyan particles C can move through the yellow particles so that a layer of the cyan particles and a layer of the yellow particles are formed. According to the experiments conducted by the present inventors, the particle diameter of the yellow particles Y2 needs to be at least 10 times as large as that of the cyan particles C. Moreover, in the experiments conducted by the present inventors, particles having a diameter of 500 nm or less start to move from the electrode when an electric field is applied at an intensity of 0.3 v/μm for about 0.1 second, whereas particles having a diameter of 5 μm or more reach the opposite electrode within this time period.

By applying a short-time pulse voltage in a manner as described above, only the yellow particles Y2 move to the opposite electrode and a red color ((c) in FIG. 6) or a cyan color ((d) in FIG. 6) is displayed.

—White Color Display and Black Color Display—

After applying a voltage V that satisfies |V|>|V1| for a short period of time to the display medium being in a state of (a) in FIG. 6 (magenta color display) or in a state of (b) in FIG. 6 (green color display), a voltage that satisfies |V2|>|V| is applied. More specifically, when a low voltage V (voltage at which the flocculation MY do not decompose; |V2|>|V|) is applied when the cyan particles C are released from the display side electrode 3, the cyan particles C, the magenta particles M, and the yellow particles Y2 are moved to form a flocculation CMY. This flocculation CMY, which is formed from the three kinds of electrophoretic particles at a position away from the electrodes, moves as the flocculation to the rear electrode 4 to display a white color ((e) in FIG. 6) or to the display side electrode 3 to display a black color ((f) in FIG. 6).

—Blue Color Display and Yellow Color Display—

When a voltage V that satisfies the relationship |V1|>|V|>|V2| is applied to the display medium being in a state of (e) in FIG. 6 (white color display) or in a state of (f) in FIG. 6 (black color display), the yellow particles Y2 separate from the flocculation CMY.

Accordingly, when a voltage V that satisfies the relationship V1>V>V2 is applied to the display medium displaying a white color such that the display side electrode 3 is positive and the rear electrode 4 is negative, the yellow particles Y2 remain in a state of being attached to the rear electrode, whereas the flocculation CM that is as a whole negatively charged moves to the display side electrode 3, whereby a blue color is displayed.

in contrast, when a voltage V that satisfies a relationship −V1<V<−V2 is applied to the display medium displaying a black color such that the display side electrode 3 is negative and the rear electrode 4 is positive, the yellow particles Y2 remain in a state of being attached to the display side electrode, whereas the flocculation CM moves to the rear electrode 4, whereby a yellow color is displayed.

As described above, by using three kinds of electrophoretic particles including one kind of particles having a small diameter that forms a flocculation with a different kind of particles and two kinds of particles that have a diameter large than that of the smaller particles and a responsiveness higher than that of the smaller particles, and form an flocculation with a different kind of particles, eight colors can be displayed by utilizing differences in the flocculating force and the responsiveness among these particles, and controlling the intensity of the voltage applied between electrodes and the application time thereof.

Hereinafter, the electrophoretic particles and the dispersion medium to be used in this exemplary embodiment will be more specifically described.

The electrophoretic particles (charged particles) to be used in this exemplary embodiment include colored particles containing a polymer having a charging group and a colorant, and a reactive silicone polymer or a reactive long chain alkyl polymer that is bound to the surface of the colored particles or covers the surface of the colored particles. More specifically, the charged particles according to this exemplary embodiment are: 1) charged particles in which a reactive silicone polymer is bound to the surface of colored particles or covers the surface of the colored particles; or 2) charged particles in which a reactive long chain alkyl polymer is bound to the surface of colored particles or covers the surface of the colored particles. The dispersion medium used in this exemplary embodiment may be those explained as a first solvent utilized in the production method of the particles as described later.

The charged particles according to this exemplary embodiment move in response to the electric field, and have charging properties when the particles are dispersed in a dispersion medium and move in the dispersion medium according to the formed electric field. By having a structure as described above, the charged particles (dispersion for display) according to this exemplary embodiment exhibit stable dispersibility and charging properties. The charging properties include a charge polarity and a charge amount of the particles. In this exemplary embodiment, changes in the charge polarity and the charge amount may be suppressed and stabilized.

Since the charged particles according to this exemplary embodiment have the properties as described above, stable dispersibility and charging properties are maintained even in a system in which two or more kinds of charged particles having different charge polarities are mixed. The two or more kinds of charged particles having different charge polarities may be obtained by, for example, changing a charging group of a polymer having the charging group as described later.

The colored particles contain a polymer having a charging group, a colorant, and other components as necessary.

The polymer having a charging group is a polymer having a cationic group or an anionic group as a charging group, for example. Examples of the cationic group as the charging group include an amino group and a quaternary ammonium group (including salts of these groups). The cation group imparts a positive charge polarity to the particles. Examples of the anionic group as the charging group include a phenol group, a carboxyl group, a carboxylate group, a sulfonic acid group, a sulfonate group, a phosphoric acid group, a phosphate group and a tetraphenylboron group (including salts of these groups). The anionic group imparts a negative charge polarity to the particles.

The polymer having a charging group may be, specifically, a homopolymer of a monomer having a charging group, or a copolymer of a monomer having a charging group and a further monomer (a monomer having no charging group), for example.

Examples of the monomers having a charging group include a monomer having a cationic group (hereinafter, a cationic monomer) and a monomer having an anionic group (hereinafter, an anionic monomer).

Specific examples of the cationic monomer include (meth)acrylates having an aliphatic amino group, such as N,N-dimethylaminoethyl (meth)acrylate, N,N-diethylaminoethyl (meth)acrylate, N,N-dibutylaminoethyl (meth)acrylate, N,N-hydroxyethylaminomethyl (meth)acrylate, N-ethylaminoethyl (meth)acrylate, N-octyl-N-ethylaminoethyl (meth)acrylate, and N,N-dihexylaminomethyl (meth)acrylate; aromatic group-substituted ethylenic monomers having a nitrogen-containing group, such as dimethylaminostyrene, diethylaminostyrene, dimethylaminomethylstyrene, and dioctylaminostyrene; nitrogen-containing vinyl ether monomers, such as vinyl-N-ethyl-N-phenylaminoethyl ether, vinyl-N-butyl-N-phenylaminoethyl ether, triethanolamine divinyl ether, vinyl diphenyl aminoethyl ether, N-vinylhydroxyethyl benzamide, and m-aminophenyl vinyl ether; pyrroles, such as vinyl amine and N-vinyl pyrrole; pyrrolines, such as N-vinyl-2-pyrroline and N-vinyl-3-pyrroline; pyrrolidines, such as N-vinylpyrrolidine, vinylpyrrolidine amino ether, and N-vinyl-2-pyrrolidone; imidazoles, such as N-vinyl-2-methylimidazole; imidazolines, such as N-vinylimidazoline; indoles, such as N-vinylindole; indolines, such as N-vinylindoline; carbazoles, such as N-vinylcarbazole and 3,6-dibromo-N-vinylcarbazole; pyridines, such as 2-vinylpyridine, 4-vinylpyridine, and 2-methyl-5-vinylpyridine; piperidines, such as (meth)acrylpiperidine, N-vinylpiperidone, and N-vinylpiperazine; quinolines, such as 2-vinylquinoline and 4-vinylquinoline; pyrazoles, such as N-vinylpyrazole and N-vinylpyrazoline; oxazoles, such as 2-vinyloxazole; and oxazines, such as 4-vinyloxazine and morpholinoethyl (meth)acrylate.

Examples of the cationic monomers that are particularly preferable from the viewpoint of general versatility include (meth)acrylates having an aliphatic amino group, such as N,N-dimethylaminoethyl(meth)acrylate and N,N-diethylaminoethyl(meth)acrylate, and these monomers are particularly preferably used in the form of a quaternary ammonium salt before or after the polymerization. The quaternary ammonium salt can be obtained by reacting the compounds mentioned above with alkyl halides or tosyl esters.

Examples of the anionic monomers include carboxylic acid monomers, such as (meth)acrylic acid, crotonic acid, itaconic acid, maleic acid, fumaric acid, citraconic acid, and anhydrides thereof and monoalkyl esters thereof, and vinyl ethers having a carboxyl group, such as carboxyethyl vinyl ether and carboxypropyl vinyl ether.

Examples of the sulfonic acid monomers include styrenesulfonic acid, 2-acrylamide-2-methylpropanesulfonic acid, 3-sulfopropyl(meth)acrylic acid ester, bis-(3-sulfopropyl)-itaconic acid ester, and salts thereof. Further examples include a sulfuric acid monoester or a salt of 2-hydroxyethyl (meth)acrylic acid.

Examples of the phosphoric acid monomers include vinylphosphonic acid, vinyl phosphate, acid phosphoxyethyl (meth)acrylate, acid phosphoxypropyl (meth)acrylate, bis(methacryloxyethyl) phosphate, diphenyl-2-methacryloyloxyethyl phosphate, diphenyl-2-acryloyloxyethyl phosphate, dibutyl-2-methacryloyloxyethyl phosphate, dibutyl-2-acryloyloxyethyl phosphate, and dioctyl-2-(meth)acryloyloxyethyl phosphate.

The anionic monomers are preferably those having (meth)acrylic acid or sulfonic acid, and more preferably those in the form of an ammonium salt before or after the polymerization. The ammonium salt can be obtained by reaction with a tertiary amine or a quaternary ammonium hydroxide.

Examples of the further monomer include nonionic monomers, such as (meth)acrylonitrile, (meth)acrylic acid alkyl ester, (meth)acrylamide, ethylene, propylene, butadiene, isoprene, isobutylene, N-dialkyl-substituted (meth)acrylamide, styrene, vinyl carbazole, styrene, styrene derivatives, polyethylene glycol mono(meth)acrylate, vinyl chloride, vinylidene chloride, isoprene, butadiene, vinyl pyrrolidone, hydroxyethyl(meth)acrylate, and hydroxybutyl(meth)acrylate.

The copolymerization ratio of the monomer having a charging group to the further monomer may vary as appropriate according to the desired charge amount of the particles. Typically, the copolymerization ratio by mole of the monomer having a charging group to the further monomer is selected from the range of from 1:100 to 100:0.

The weight-average molecular weight of the polymer having a charging group is preferably from 1,000 to 1,000,000 and more preferably from 10,000 to 200,000.

Next, a colorant will be described. The colorant may be organic or inorganic pigments, oil soluble dyes, and the like, and examples thereof include known colorants, including magnetic powders, such as magnetite and ferrite, carbon black, titanium oxide, magnesium oxide, zinc oxide, a phthalocyanine copper cyan coloring material, an azo yellow coloring material, an azo magenta coloring material, a quinacridone magenta coloring material, a red coloring material, a green coloring material, and a blue coloring material. Specific typical examples include aniline blue, calco oil blue, chrome yellow, ultramarine blue, DuPont oil red, quinoline yellow, methylene blue chloride, phthalocyanine blue, malachite green oxalate, lamp black, rose bengal, C.I. Pigment Red 48:1, C.I. Pigment Red 122, C.I. Pigment Red 57:1, C.I. Pigment Yellow 97, C.I. Pigment Blue 15:1, and C.I. Pigment Blue 15:3.

The amount of the colorant is preferably from 10% by weight to 99% by weight, more preferably from 30% by weight to 99% by weight, with respect to the amount of the polymer having a charging group.

Next, other blending materials will be described. Examples of the blending materials include charge control agents and magnetic materials.

Examples of the charge control agents include known charge control agents for use in electrophotographic toner materials, such as: cetylpyridium chloride; quaternary ammonium salts, such as BONTRON P-51, BONTRON P-53, BONTRON E-84, and BONTRON E-81 (all trade names, manufactured by Orient Chemical Industries Co., Ltd.); salicylic acid metal complexes; phenol condensates; tetraphenyl compounds; metal oxide particles; and metal oxide particles having the surface treated with various coupling agents.

As the magnetic material, inorganic or organic magnetic materials coated with a colorant as necessary may be used. Transparent magnetic materials, particularly transparent organic magnetic materials, are more preferable since these materials do not inhibit the color development of the colorant and have a specific gravity smaller than that of the inorganic magnetic materials.

Examples of the colored magnetic materials (i.e. color-coated materials) include the colored magnetic powder having a small diameter described in JP-A No. 2003-131420. A magnetic material including magnetic particles as a core and a colored layer disposed on the surface of the magnetic particles may be used. The colored layer may be appropriately selected from an opaque layer that colors the magnetic particles by a pigment or the like, but, a light-interference thin film is preferable. The light-interference thin film is a thin film of an achromatic material such as SiO₂ or TiO₂, which has a thickness equivalent to the light wavelength and selectively reflects light of a specific wavelength by means of light interference occurring in the thin film.

Next, the reactive silicone polymer and the reactive long chain alkyl polymer, which are bound to the surface of the colored particles or cover the surface of the colored particles, will be described.

The reactive silicone polymer and the reactive long chain alkyl polymer are reactive dispersants, and examples thereof include the following substances.

One example of the reactive silicon polymer includes a copolymer containing the following components (A. silicone chain components, B. reactive components, and C. other copolymerizable components).

A. Silicone Chain Components

Examples of the silicone chain components include dimethyl silicone monomers having a (meth)acrylate group at one terminal thereof (e.g., SILAPLANE FM-0711, SILAPLANE FM-0721, and SILAPLANE FM-0725 (all trade names, manufactured by Chisso Corporation) and X-22-174DX, X-22-2426, and X-22-2475 (all trade names, manufactured by Shin-Etsu Silicone Co., Ltd.)

B. Reactive Components

Examples of the reactive components include glycidyl (meth)acrylate and isocyanate monomers (KARENZ AOI and KARENZ MOI (all trade names, manufactured by Showa Denko K. K.).

C. Other Copolymerizable Components

Examples of the other copolymerizable components include alkyl(meth)acrylates, such as methyl(meth)acrylate, ethyl(meth)acrylate, propyl(meth)acrylate, and butyl(meth)acrylate, hydroxyethyl(meth)acrylate, hydroxybutyl(meth)acrylate, a monomer having an ethylene oxide unit, including alkyloxyoligoethylene glycol(meth)acrylate such as tetraethylene glycol monomethyl ether (meth)acrylate), a (meth)acrylate having polyethylene glycol at one terminal thereof, (meth)acrylic acid, maleic acid, and N,N-dialkylamino(meth)acrylate.

Among the above, the components A and B are essential ingredients and the component C may be optionally copolymerized.

The copolymerization ratio of these three components is preferably such that the silicone chain component A is 80% by weight or more, and more preferably 90% by weight or more, in order to obtain charged particles that can electrophoretically move independently or as a flocculation with a different kind of particles. When the proportion of the non-silicone chain component is more than 20 wt %, the surface-activating ability may decrease. As a result, the diameter of the particles to be formed may increase, the formed particles may easily flocculate, or the particles may become difficult to electrophoretically move independently. The proportion of the reactive component B is preferably in the range of from 0.1% by weight to 10% by weight. When the proportion of the reactive component B is more than 10% by weight, reactive groups may remain in the formed electrophoretic particles, thereby making it easier to cause flocculation of the particles. When the proportion of the reactive component B is lower than 0.1% by weight, binding to the particle surface may be insufficient.

Examples of the reactive silicone compound other than the copolymers mentioned above include silicone compounds having an epoxy group at one terminal thereof, such as X-22-173DX (trade name, manufactured by Shin-Etsu Silicone Co., Ltd.) Among the above, copolymers containing at least two components, i.e., a dimethyl silicone monomer having a (meth)acrylate group at one terminal thereof (e.g., SILAPLANE FM-0711, SILAPLANE FM-0721, and SILAPLANE FM-0725, all trade names, manufactured by Chisso Corporation and X-22-174DX, X-22-2426, and X-22-2475 (all trade names, manufactured by Shin-Etsu Silicone Co., Ltd.) and a glycidyl(meth)acrylate or an isocyanate monomer (KARENZ AOI and KARENZ MOI, all trade names, manufactured by Showa Denko K. K.) are preferable from the viewpoint of achieving excellent reactivity and excellent surface-activating ability.

The weight-average molecular weight of the reactive silicone polymer is preferably from 1,000 to 1,000,000, and more preferably from 10,000 to 1,000,000.

The reactive long chain alkyl polymer may have a similar structure to that of the silicone copolymer as mentioned above. Examples thereof include a silicone copolymer in which a long chain alkyl (meth)acrylate is used as a long chain alkyl component A′ in place of the silicone chain component A. Specific preferable examples of the long chain alkyl(meth)acrylate include those having an alkyl chain having 4 or more carbon atoms, and examples thereof include butyl(meth)acrylate, hexyl(meth)acrylate, 2-ethylhexyl(meth)acrylate, dodecyl(meth)acrylate, and stearyl(meth)acrylate. Among the above, copolymers containing at least two components, i.e., a long chain alkyl(meth)acrylate and a glycidyl(meth)acrylate or an isocyanate monomer (KARENZ AOI and KARENZ MOI, all trade names, manufactured by Showa Denko K. K.) from the viewpoint of achieving excellent reactivity and excellent surface-activating ability. The formulation ratio of the components A′, B and C in the copolymer may be selected from the same range as that of the reactive silicone polymer as described above.

The reactive long chain alkyl polymer refers to, for example, a polymer having an alkyl chain of about 4 to about 30 carbon atoms at its side chain.

The weight-average molecular weight of the reactive long chain alkyl polymer is preferably from 1,000 to 1,000,000, and more preferably from 10,000 to 1,000,000.

The reactive silicone polymer or the reactive long chain alkyl polymer is bound to the surface of the colored particles or covers the surface of colored particles. The term “bound” means that a reactive group of the polymer is bound to a functional group (which may also serve as the charging group) that is present on the surface of colored particles. The term “covers” means that the reactive group of the reactive polymer forms a layer on the colored particles by causing reaction, such as polymerization, with the functional groups present on the surface of the colored particles or with a chemical substance separately added to the system. Methods of selectively performing the binding or covering include, when binding is desired, selecting a reactive silicone polymer or a reactive long chain alkyl polymer having a reactive group that aggressively binds to the functional group (or charging group) is selected as described above (e.g., selecting an acidic group, an acidic base, an alcoholate group, or a phenolate group as the functional group present on the particles, and selecting an epoxy group or an isocyanate group as the reactive group); and when covering is desired, selecting a reactive silicone polymer or a reactive long chain alkyl polymer whose reactive groups are bound to one another via a functional group (charging group) as a catalyst (e.g., selecting an amino group or an ammonium group as the functional group (charging group), and selecting an epoxy group as the reactive group).

The method for binding the reactive silicon polymer or the reactive long chain alkyl polymer to the surface of the colored particles, or the method for covering the surface of the colored particles with the reactive silicon polymer or reactive long chain alkyl polymer, may be carried out by heating or the like. From the viewpoint of dispersibility, the amount of binding or covering is preferably in the range of from 2% by weight to 200% by weight with respect to the weight of the particles. When this amount is lower than 2% by weight, dispersibility of the particles may deteriorate, and when this amount is more than 200% by weight, the charge amount of the particles may decrease.

The amount of binding or covering may be determined as follows. One example is to allow the produced particles to centrifugal sedimentation and then measure the weight thereof, and calculate the increment of weight with respect to the amount of the materials for the particles. Another example is to calculate the amount of binding or covering by analyzing the composition of the particles.

Next, a method for producing the charged particles according to the exemplary embodiment will be described.

The method for producing the charged particles according to this exemplary embodiment includes: stirring and emulsifying a mixed solution containing a polymer having a charging group, a colorant, a reactive silicone polymer or a reactive long chain alkyl polymer, a first solvent, and a second solvent which is incompatible with the first solvent and has a boiling point lower than that of the first solvent, the second solvent dissolving the polymer having a charging group; removing the second solvent from the emulsified mixed solution to form colored particles including the polymer having a charging group and the colorant; and reacting the reactive silicone polymer or the reactive long chain alkyl polymer with the colored particles so as to bind to the surface of the colored particles or cover the surface of the colored particles. When the charged particles are produced by a so-called dry-in-liquid method, those having particularly stable dispersibility and charging properties may be obtained.

In this method, a dispersion medium that is used also as a display medium may be used as the first solvent to prepare a dispersion including the charged particles and a dispersion medium. In this way, a dispersion including charged particles and a dispersion medium may be prepared in a simple manner without undergoing a washing or drying process. However, in order to improve electrical characteristics, washing of the particles (i.e. removal of ionic impurities) or replacement of the dispersion medium may be carried out as appropriate.

The method for producing the charged particles according to the exemplary embodiment is not limited to the process described above. One exemplary method includes forming colored particles by a known method (e.g., a coacervation method, a dispersion polymerization method, or a suspension polymerization method), dispersing the colored particles in a solvent containing a reactive silicone polymer or a reactive long chain alkyl polymer, and reacting the colored particles with the reactive silicone polymer or the reactive long chain alkyl polymer, whereby the reactive silicone polymer or the reactive long chain alkyl polymer are bound to the surface of the colored particles or cover the surface of the colored particles.

Hereinafter, the method for producing the charged particles according to this exemplary embodiment will be described in detail with reference to the respective processes of the method.

—Emulsification Process—

In the emulsification process, for example, two kinds of solutions, i.e., a solution containing a reactive silicone polymer or a reactive long chain alkyl polymer and a first solvent, and a solution containing a polymer having a charging group, a colorant, and a second solvent that is incompatible with the first solvent and has a boiling point lower than that of the first solvent, the second solvent dissolving a polymer having a charging group, are mixed by stirring and emulsified. The mixed solutions to be emulsified may contain other components than the materials mentioned above (e.g. a charge control agent or a pigment dispersant) as necessary.

In the emulsification process, by stirring the mixed solution, the second solvent having a low-boiling point forms a dispersed phase in the form of droplets in a continuous phase formed by the high-boiling solution (the first solvent and the reactive polymer) as the first solvent, thereby obtaining an emulsion. The reactive silicon polymer or the reactive long chain alkyl polymer is dissolved in the continuous phase of the first solvent, and the polymer having a charging group and the colorant is dissolved or dispersed in the second solvent.

In the emulsification process, the respective materials may be mixed separately, but are preferably mixed in the following manner. First, a first mixed solution is prepared by mixing the polymer having a charging group, the colorant, and the second solvent, and a second mixed solution is prepared by mixing the reactive silicone polymer or the reactive long chain alkyl polymer and the first solvent. Then, the first mixed solution is dispersed and mixed in the second mixed solution, and the resultant mixture is emulsified so that the first mixed solution is dispersed in the second mixed solution in the form of particles. It is also preferred to prepare the second mixed solution by adding a monomer for forming the reactive silicone polymer or the reactive long chain alkyl polymer to the first solvent, and then polymerizing the monomer to produce the reactive silicone polymer or the reactive long chain alkyl polymer.

Stirring for emulsification may be carried out by using, for example, a stirring apparatus (e.g., a homogenizer, a mixer, or an ultrasonic disintegrator). In order to suppress the increase in temperature during the emulsification, the temperature of the mixed liquid during the emulsification is preferably kept at from 0° C. to 50° C. For example, the stirring speed of a homogenizer or a mixer for emulsification, the output power of an ultrasonic disintegrator, or the emulsification time may be determined according to a desired particle diameter.

Next, the first solvent will be described.

The first solvent is used as a poor solvent capable of forming a continuous phase in the mixed solution. Examples of the first solvent include, but are not limited thereto, petroleum-derived high-boiling-point solvents, such as paraffin hydrocarbon solvents, silicone oils, and fluorine-containing liquids. From the viewpoint of obtaining charged particles having stable dispersibility and charging properties, when a reactive silicone polymer is used, a silicone oil is preferably used; and when a reactive long chain alkyl polymer is used, a paraffin hydrocarbon solvent is preferably used.

Specific examples of the silicone oil include silicone oils having a hydrocarbon group bound to a siloxane bond (e.g., dimethyl silicone oil, diethyl silicone oil, methyl ethyl silicone oil, methyl phenyl silicone oil, and diphenyl silicone oil) and modified silicone oils (e.g., fluorine-modified silicone oil, amine-modified silicone oil, carboxyl-modified silicone oil, epoxy-modified silicone oil, and alcohol-modified silicone oil). Among them, dimethyl silicone is particularly preferable from the viewpoint of high safety, high chemical stability, excellent long-term reliability, and high resistivity.

The viscosity of the silicone oil is preferably from 0.1 mPa·s to 20 mPa·s and more preferably from 0.1 mPa·s to 2 mPa·s at a temperature of 20° C. When the viscosity falls within this range, the migration speed of particles, i.e., display speed, may be improved. The viscosity is determined by using a B-8L viscometer (trade name, manufactured by Tokyo Keiki Co., Ltd.).

Examples of the paraffin hydrocarbon solvent include normal paraffin hydrocarbons and iso-paraffin hydrocarbons having 20 or more carbon atoms (boiling point: 80° C. or higher). From the viewpoint of safety and volatility, iso-paraffin is preferably used. Specific examples include SHELLSOL 71 (trade name, manufactured by Shell Oil Co.), ISOPAR O, ISOPAR H, ISOPAR K, ISOPAR L, ISOPAR G, and ISOPAR M (all trade names, manufactured by Exxon Mobil Corporation), and IP Solvent (trade name, manufactured by Idemitsu Kosan Co., Ltd.).

Next, the second solvent will be described.

The second solvent is used as a good solvent capable of forming a disperse phase in a mixed solution. The second solvent is selected from solvents that are incompatible with the first solvent, have a boiling point lower than that of the first solvent, and dissolve the polymer having a charging group. The term “incompatible” as used herein refers to a state in which plural kinds of substances are each forming an independent phase without mixing with each other. The term “dissolve” as used herein refers to a state in which the remaining of an undissolved material is not confirmed by visual observation.

Examples of the second solvent include, but are not limited thereto, water; lower alcohols having 5 or less carbon atoms (e.g., methanol, ethanol, propanol, and isopropyl alcohol) tetrahydrofuran, acetone, and other organic solvents (e.g., toluene, dimethylformamide, and dimethylacetamide).

In order that the second solvent can be removed from the mixed solution system by, for example, heating under reduced pressure, the second solvent is selected from solvents having a boiling point lower than that of the first solvent. The boiling point of the second solvent is, for example, preferably from 50° C. to 200° C. and more preferably from 50° C. to 150° C.

—Second Solvent Removal Process—

In a second solvent removal process, the second solvent (low-boiling solvent) is removed from the mixed solution that has been emulsified in the emulsification process. By removing the second solvent, the polymer having a charging group precipitates and forms particles while enclosing other materials within the particles in the disperse phase formed by the second solvent, whereby colored particles are obtained. Various additives, such as a pigment dispersant or a weathering stabilizer, may also be included in the polymer that forms the particles. For example, when a commercially available pigment dispersion, which contains a polymeric substance or a surfactant for dispersing the pigment, is used, the obtained colored particles include these substances in addition to the charge controlling resin.

Examples of the method for removing the second solvent include a method for heating the mixed solution, a method for depressurizing the mixed solution, and a combination of these methods.

When the second solvent is removed by heating the mixed solution, the heating temperature is preferably, for example, from 30° C. to 200° C. and more preferably from 50° C. to 180° C. It is also possible to allow the reactive silicone polymer or the reactive long chain alkyl polymer to react with the surface of the particles by performing heating in the second solvent removal process. When the second solvent is removed by depressurizing the mixed solution, the depressurization pressure is preferably from 0.01 to 200 mPa and more preferably from 0.01 to 20 mPa.

—Bonding or Covering Process—

In a bonding or covering process, the reactive silicone polymer or the reactive long chain alkyl polymer is allowed to react in the solution (first solvent) in which the colored particles have been formed, and is bound to or cover the surface of the colored particles. It may be possible that the reaction is promoted by the heat treatment in the second solvent removal process, but a more reliable reaction can be achieved more reliably by undergoing this process.

Examples of the method including reacting the polymer to be bound to or cover the surface of the colored particles include, according to the type of the polymer, a method for heating the solution.

When the solution is heated, the heating temperature is, for example, preferably from 50° C. to 200° C. and more preferably from 60° C. to 150° C.

Through the process as described above, charged particles or a charged particle dispersion liquid containing the charged particles are obtained. To the charged particle dispersion liquid, an acid, an alkali, a salt, a dispersant, a dispersion stabilizer, a stabilizer for preventing oxidation, for absorbing ultraviolet light, or the like, an antibacterial agent, a preservative, or the like may be added as required.

To the charged particle dispersion liquid, an anionic surfactant, a cationic surfactant, an amphoteric surfactant, a nonionic surfactant, a fluorine-containing surfactant, a silicone surfactant, a silicone cationic compound, a silicone anionic compound, a metal soap, an alkyl phosphoric acid ester, a succinic acid imide, or the like may be added as a charge controlling agent.

Examples of the charge controlling agent include ionic or nonionic surfactants, block or graft copolymers having lipophilic and hydrophilic moieties, compounds having a polymer chain skeleton, such as cyclic, star-shaped, or dendritic polymers (dendrimers), metal complexes of salicylic acid, metal complexes of catechol, metal-containing bisazo dyes, tetraphenyl borate derivatives, and copolymers of a polymerizable silicone macromer (SILAPLANE, trade name, manufactured by Chisso Corporation) and an anionic monomer or a cationic polymer.

Specific examples of the ionic and nonionic surfactants include the following substances. Examples of the nonionic surfactants include polyoxyethylene nonylphenyl ether, polyoxyethylene octylphenyl ether, polyoxyethylene dodecylphenyl ether, polyoxyethylene alkyl ether, polyoxyethylene fatty acid ester, sorbitan fatty acid ester, polyoxyethylene sorbitan fatty acid ester, and fatty acid alkylolamide. Examples of the anionic surfactants include alkylbenzene sulfonate, alkylphenyl sulfonate, alkylnaphthalene sulfonate, higher fatty acid salts, sulfuric acid ester salts of higher fatty acid esters, and sulfonic acids of higher fatty acid esters. Examples of the cationic surfactants include primary to tertiary amine salts and quaternary ammonium salts. The amount of the charge controlling agent is preferably from 0.01 to 20% by weight and more preferably from 0.05 to 10% by weight relative to the solid contents of the particles.

The obtained charged particle dispersion liquid may be diluted as required with the first solvent (or the first solvent (including a dispersant as required)).

The concentration of the charged particles in the display particle dispersion liquid varies depending on the display properties, responsibilities or applications thereof, and is preferably selected from the range of from 0.1% by weight to 30% by weight. When plural kinds of particles having different colors are mixed, the total amount of these particles preferably falls within this range. When the concentration is lower than 0.1% by weight. The display density may be insufficient, while when the concentration is higher than 30% by weight, the display speed may decrease and the particles tend to flocculate.

### EXAMPLES

Hereinafter, the Examples will be described, but the present invention is not limited to these Examples.

—Preparation of White Particles—

In a 100 ml three-neck flask provided with a reflux condenser, 5 parts by weight of 2-vinyl naphthalene (manufactured by Nippon Steel Chemical Co., Ltd.), 5 parts by weight of a silicone monomer FM-0721 (trade name, manufactured by Chisso Corp.), 0.3 parts by weight of lauroyl peroxide (manufactured by Wako Pure Chemical Industries, Ltd.) as an initiator, and 20 parts by weight of silicone oil KF-96L-1 CS (trade name, manufactured by Shin-Etsu Chemicals Co., Ltd.) are added. Then, babbling is carried out using a nitrogen gas for 15 minutes, and thereafter polymerization is carried out at 65° C. for 24 hours under a nitrogen atmosphere.

The solid content of the resultant is adjusted to 40% by weight with a silicone oil, thereby obtaining white particles. The particle diameter of the white particles is 450 nm.

—Silicone Polymer A—

12 parts by weight of SILAPLANE FM-0725 (trade name, manufactured by Chisso Corporation, weight average molecular weight Mw=10000) as a first silicone monomer (first silicone chain component), 36 parts by weight of SILAPLANE FM-0721 (trade name, manufactured by Chisso Corporation, weight average molecular weight Mw=5000) as a second silicone monomer (second silicone chain component), 20 parts by weight of phenoxy ethylene glycol acrylate (AMP-10G, trade name, manufactured by Shin-Nakamura Chemical Co., Ltd.), and 32 parts by weight of hydroxyethyl methacrylate (manufactured by Wako Pure Chemical Industries, Ltd. company) as a further monomer (further copolymerization component) are mixed with 300 parts by weight of isopropyl alcohol (IPA). Then, 1 part by weight of AIBN (2,2-azobis isobutyl nitrile) is dissolved as a polymerization initiator, and polymerization is carried out at 70° C. for 6 hours under nitrogen. The product thus obtained is purified using hexane as a re-precipitation solvent, and then dried, thereby obtaining a silicone polymer A.

—Silicone Polymer B—

19 parts by weight of SILAPLANE FM-0725 (trade name, manufactured by Chisso Corporation, weight average molecular weight Mw=10000) as a first silicone monomer (first silicone chain component), 29 parts by weight of SILAPLANE FM-0721 (trade name, manufactured by Chisso Corporation, Weight average molecular weight Mw=5000) as a second silicone monomer (second silicone chain component), 9 parts by weight of methyl methacrylate (manufactured by Wako Pure Chemical Industries, Ltd.), 5 parts by weight of octafluoropentyl methacrylate, and 38 parts by weight of hydroxyethyl methacrylate (manufactured by Wako Pure Chemical Industries, Ltd.) as a further monomer (further copolymerization component) are mixed with 300 parts by weight of isopropyl alcohol (IPA). Then, 1 part by weight of AIBN (2,2-azobis isobutyl nitrile) is dissolved as a polymerization initiator, and polymerization is carried out at 70° C. for 6 hours under nitrogen. The product thus obtained is purified using hexane as a re-precipitation solvent, and then dried, thereby obtaining a silicone polymer B.

—Synthesis of Cyan Electrophoretic Particles C1—

0.5 g of the silicone polymer A are added to 9 g of isopropyl alcohol (IPA), and dissolved. Thereafter, 0.5 g of a cyan pigment (CYANINE BLUE 4973, trade name, manufactured by Sanyo Color Works, Ltd.) are added, and then dispersed using zirconia balls having a diameter of 0.5 mm for 48 hours, thereby obtaining a pigment-containing polymer solution.

3 g of the pigment-containing polymer solution are taken out, and heated to 40° C. Thereafter, 12 g of 2 CS silicone oil (KF96, trade name, manufactured by Shin-Etsu Chemicals Co., Ltd.) are added dropwise in small quantities while applying ultrasonic waves. In this way, the silicone polymer is allowed to deposit on the pigment surface. Thereafter, the solution is heated to 60° C. and dried under reduced pressure to evaporate the IPA, thereby obtaining cyan particles in which the silicone polymer is attached to the pigment surface. Thereafter, the particles of the solution are separated with a centrifuge, the supernatant liquid is removed, 5 g of the silicone oil are added, ultrasonic waves are applied, washing is performed, particles are separated with a centrifuge, the supernatant liquid is removed, and 5 g of the silicone oil are further added, thereby obtaining a cyan particle dispersion liquid.

The volume average particle diameter of the obtained cyan particles is 0.2 μm. The charge polarity of the particles in this dispersion liquid is determined by placing the dispersion liquid between two electrode substrates, applying a direct-current voltage, and evaluating the direction of electrophoretic movement, and the result is found to be positive.

—Synthesis of Magenta Electrophoretic Particles M1—

A magenta particle dispersion liquid is obtained in the same manner as the synthesis of the cyan electrophoretic particles C1, except that the silicone polymer B is used in place of the silicone polymer A and a magenta pigment (PIGMENT RED 3090, trade name, manufactured by Sanyo Color Works, Ltd.) in place of the cyan pigment used in the synthesis of the cyan electrophoretic particles C1. The volume average particle diameter of the obtained magenta particles is 0.3 μm. The charge polarity of the particles in this dispersion liquid is determined by placing the dispersion liquid between two electrode substrates, applying a direct-current voltage, and evaluating the direction of electrophoretic movement. The result is found to be negative.

—Synthesis of Yellow Electrophoretic Particles Y1—

A yellow particle Y1 dispersion liquid is obtained in the same manner as the synthesis of the cyan electrophoretic particles C1, except that a yellow pigment (FAST YELLOW 7413, trade name, manufactured by Sanyo Color Works, Ltd.) is used in place of the cyan pigment used in the synthesis of the cyan electrophoretic particles C1. The volume average particle diameter of the obtained yellow particles is 0.3 μm. The charge polarity of the particles in this dispersion liquid is determined by placing the dispersion liquid between two electrode substrates, applying a direct-current voltage, and evaluating the direction of electrophoretic movement. The result is found to be positive.

—Synthesis of Large Yellow Particles Y2—

53 parts by weight of methyl methacrylate, 0.3 parts by weight of 2-(diethyl amino)ethyl methacrylate, and 1.5 parts by weight of a yellow pigment (FAST YELLOW 7416: trade name, manufactured by Sanyo Color Works, Ltd.) are mixed. Then, ball milling is carried out using zirconia balls having a diameter of 10 mm for 20 hours, thereby preparing a dispersion liquid A-1.

Next, 40 parts by weight of calcium carbonate and 60 parts by weight of water are mixed, and pulverized in a ball mill in a similar manner to the above, thereby obtaining a calcium carbonate dispersion liquid A-2.

Furthermore, 60 g of the calcium carbonate dispersion liquid A-2 and 4 g of a 20% salt solution are mixed, the mixture is degassed for 10 minutes with an ultrasonic machine, and then the resultant mixture is stirred with an emulsifier, thereby preparing a mixed solution A-3.

20 g of the dispersion liquid A-1, 0.6 g of ethylene glycol dimethacrylate, 0.2 g of a polymerization initiator V601 (trade name, dimethyl 2,2′-azobis(2-methylpropionate), manufactured by Wako Pure Chemical Industries, Ltd.) are measured and sufficiently mixed, and then degassed for 10 minutes with an ultrasonic machine. The resultant mixture is added to the mixed liquid A-3, and then emulsified with an emulsifier. Next, the emulsified liquid is placed in a flask, sealed with a silicone cap, sufficiently degassed using an injection needle, and then filled with a nitrogen gas. Next, the resultant emulsified liquid is allowed to react at 65° C. for 15 hours, thereby preparing particles. After cooling, the particles are filtered, the obtained particle powder is dispersed in ion exchanged water, and then calcium carbonate is decomposed with hydrochloric acid water, and a further filtration is carried out. Thereafter, the particles are washed with a sufficient amount of distilled water, and sieved through nylon sieves each having an opening of 15 μm and 10 μm to make the particle diameter uniform. The volume average primary particle diameter of the obtained particles is 13 μm.

Thereafter, the obtained large yellow particles are subjected to the following surface treatment.

95 parts by weight of SILAPLANE FM-0711 (trade name, manufactured by Chisso Corp., weight average molecular weight Mw=1000), 2 parts by weight of glycidyl methacrylate (manufactured by Wako Pure Chemical Industries, Ltd.) and 3 parts by weight of methyl methacrylate (manufactured by Wako Pure Chemical Industries, Ltd.) are mixed with 300 parts by weight of isopropyl alcohol (IPA). Then, 1 part by weight of AIBN (2,2-azobisisobutyl nitrile) is dissolved as a polymerization initiator, and polymerized at 7° C. for 6 hours under nitrogen. Thereafter, 300 parts by weight of a silicone oil (KF96, trade name, manufactured by Shin-Etsu Chemicals Co., Ltd.) having a viscosity of 2 CS are added, and then the IPA is removed under reduced pressure, thereby preparing a surface treatment agent B-1.

Thereafter, 2 parts by weight of the large yellow particles obtained above are mixed with 25 parts by weight of the surface treatment agent B-1 and 0.01 parts by weight of triethylamine, and stirred at a temperature of 100° C. for 5 hours. Then, the solvent is removed by centrifugal sedimentation, and the resultant is further dried under reduced pressure, thereby obtaining surface-treated large yellow particles Y2.

The volume average particle diameter of the obtained yellow particles is 13 μm, and the charge polarity is positive.

—Synthesis of Large Yellow Particles Y3—

Large yellow particles Y3 are obtained in the same manner as the synthesis of the large yellow particles Y2, except that the following surface treatment agent B-2 is used as the surface treatment agent.

80 parts by weight of SILAPLANE FM-0711 (trade name, manufactured by Chisso Corp., weight average molecular weight Mw=1000), 2 parts by weight of glycidyl methacrylate (manufactured by Wako Pure Chemical Industries, Ltd.), and 18 parts by weight of methyl methacrylate (manufactured by Wako Pure Chemical Industries, Ltd.) are mixed with 300 parts by weight of isopropyl alcohol (IPA). Then, 1 part by weight of AIBN (2,2-azobisisobutyl nitrile) is dissolved as a polymerization initiator, and polymerized at 70° C. for 6 hours under nitrogen. Thereafter, 300 parts by weight of 2 CS silicone oil (KF96, trade name, manufactured by Shin-Etsu Chemicals Co., Ltd.) are added, and the IPA is removed under reduced pressure, thereby preparing a surface treatment agent B-2.

The volume average particle diameter of the obtained yellow particles is 13 μm, and the charge polarity is positive.

—Synthesis of Large Magenta Particles M2—

Large magenta particles M2 are obtained in the same manner as the synthesis of the large yellow particles Y3, except that a magenta pigment (PIGMENT RED 3090, trade name, manufactured by Sanyo Color Works, Ltd.) is used in place of the yellow pigment, and methacrylic acid is used in place of the 2-(diethyl amino)ethyl methacrylate.

The volume average particle diameter of the obtained magenta particles is 13 μm, and the charge polarity is negative.

### Example 1

An ITO electrode is formed on a 0.7 mm-thick glass plate as a substrate, to a thickness of 50 nm by a sputtering method. Two pieces of the ITO/glass substrates are prepared, and used as a first substrate and a second substrate. The first substrate and the second substrate are placed to face each other via a 50 μm TEFLON (registered trademark) sheet as a spacer, then this structure is fixed with a clip.

Thereafter, a mixture of 10 parts by weight of the white particle dispersion liquid, 5 parts by weight of the cyan particle C1 dispersion liquid, and 5 parts by weight of the magenta particle M1 dispersion liquid is injected into the spacer portion of the substrates, thereby producing an evaluation cell.

Using this evaluation cell, a voltage of 30 V is applied to the electrodes for 1 second such that the second electrode is positive. The dispersed negatively charged magenta particles move to the positive side electrode, i.e., the second electrode side, and the positively charged cyan particles move to the negative side electrode, i.e., the first electrode side. A magenta color is observed from the second substrate side.

Then, when a voltage of 30 V is applied to the electrodes for 1 second such that the second electrode is negative, the magenta particles move to the positive side electrode, i.e., the first electrode side, and the cyan particles move to the negative side electrode, i.e., the second electrode side. A cyan color is observed from the second substrate side.

Thereafter, when a voltage of 30 V is applied to the electrodes for 0.5 seconds and then a voltage of 15 V is applied for 1 second such that the second electrode is positive, the magenta particles and the cyan particles move to the second electrode side, i.e., the positive side electrode, as a flocculation. A blue color is observed from the second substrate side.

Then, when a voltage of 15 V is applied to the electrodes for 1 second such that the second electrode is negative, the flocculation of the magenta particles and the cyan particles moves to the first electrode side, i.e., the positive side electrode. A white color is observed from the second substrate side.

### Example 2

An ITO electrode is formed on a 0.7 mm-thick glass plate as a substrate, to a thickness of 50 nm by a sputtering method. Two pieces of the ITO/glass substrates are prepared, and used as a first substrate and a second substrate. The first substrate and the second substrate are placed to face each other via a 50 μm TEFLON (registered trademark) sheet as a spacer, then this structure is fixed with a clip.

Thereafter, a mixture of 10 parts by weight of the white particle dispersion liquid, 5 parts by weight of the cyan particle C1 dispersion liquid, 5 parts by weight of the magenta particle M1 dispersion liquid, and 2 parts by weight of the large yellow particles Y2 is injected into the spacer portion of the substrates, thereby obtaining an evaluation cell.

Using this evaluation cell, when a voltage of 30 V is applied to the electrodes for 1 second such that the second electrode is positive, the magenta particles move to the positive side electrode, i.e., the second electrode side, and the cyan particles and the yellow particles move to the negative side electrode, i.e., the first electrode side. A magenta color is observed from the second substrate side.

Then, when a voltage of 30 V is applied to the electrodes for 1 second such that the second electrode is negative, the magenta particles move to the positive side electrode, i.e., the first electrode side, and the cyan particles and the yellow particles move to the negative side electrode, i.e., the second electrode side. A green color is observed from the second substrate side.

Then, when a voltage of 15 V is applied to the electrodes for 0.2 seconds such that the second electrode is positive, the yellow particles move to the negative side electrode, i.e., the first electrode side. A cyan color is observed from the second substrate side.

While a magenta color is observed from the second electrode side, when a voltage of 15 V is applied for 0.2 seconds to the electrodes such that the second electrode is negative, the yellow particles move to the negative side electrode, i.e., the second electrode side. A red color is observed from the second substrate side.

Then, when a voltage of 30 V is applied to the electrodes for 0.5 seconds and a voltage of 15 V is applied for 1 second such that the second electrode is negative, the magenta particles and the cyan particles move to the first electrode side, i.e., the positive side electrode, as a flocculation. Then, a yellow color is observed from the second substrate side.

Thereafter, when a voltage of 15 V is applied to the electrodes for 1 second such that the second electrode is positive, the yellow particles move to the negative side electrode, i.e., the first electrode side, and the magenta particles and cyan particles move to the positive electrode side, i.e., the second electrode side, as a flocculation. A blue color is observed from the second substrate side.

Then, when a voltage of 15 V is applied to the electrodes for 0.2 seconds such that the second electrode is negative, the yellow particle move to the second electrode side, i.e., the negative electrode side. A black color is observed from the second substrate side.

While a yellow color is observed from the second substrate side, when a voltage of 15 V is applied to the electrodes for 0.2 seconds such that the second electrode is positive, the yellow particles move to the negative side electrode, i.e., the first electrode side. A white color is observed from the second substrate side.

### Example 3

An ITO electrode is formed on a 0.7 mm thick glass plate as a substrate, to a thickness of 50 nm by a sputtering method. Two pieces of the ITO/glass substrates are prepared, and used as a first substrate and a second substrate. The first substrate and the second substrate are placed to face each other via a 50 μm TEFLON (registered trademark) sheet as a spacer, then this structure is fixed with a clip.

Thereafter, a mixture of 10 parts by weight of the white particle dispersion liquid, 5 parts by weight of the cyan particle C1 dispersion liquid, 5 parts by weight of the magenta particle M1 dispersion liquid, and 5 parts by weight of the yellow particle dispersion liquid Y1 is injected into the spacer portion of the substrates, thereby obtaining an evaluation cell.

Using this evaluation cell, when a voltage of 30 V is applied to the electrodes for 1 second such that the second electrode is positive, the magenta particles move to the positive side electrode, i.e., the second electrode side, and the cyan particles and the yellow particles move to the negative side electrode, i.e., the first electrode side. A magenta color is observed the second substrate side.

Then, when a voltage of 30 V is applied to the electrodes for 1 second such that the second electrode is negative, the magenta particles move to the positive side electrode, i.e., the first electrode side, and the cyan particles and the yellow particles move to the negative side electrode, i.e., the second electrode side. A green color is observed from the second substrate side.

While a magenta color is observed from the second substrate side, when a voltage of 30 V is applied to the electrodes for 0.5 seconds, and then a voltage of 15 V is applied for 1 second such that the second electrode is negative, the magenta particles and the cyan particles move to the first electrode side, i.e., the positive electrode side, as a flocculation. A white color is observed when observed from the second substrate side.

Then, when a voltage of 15 V is applied to the electrodes for 1 second such that the second electrode is positive, a flocculation of the magenta particles, the cyan particles, and the yellow particles moves to the second electrode side, i.e., the positive electrode side. A black color is observed from the second substrate side.

Then, when a voltage of 20 V is applied to the electrodes for 1 second such that the second electrode is positive, only the yellow particles move to the first electrode side, i.e., the negative electrode side. A blue color is observed from the second substrate side.

While a white color is observed from the second electrode side, when a voltage of 20 V is applied to the electrodes for 1 second such that the second electrode is negative, only the yellow particles move to the second electrode side, i.e., the negative electrode side. A yellow color is observed from the second substrate side.

### Example 4

An ITO electrode is formed on a 0.7 mm thick glass plate as a substrate, to a thickness of 50 nm by a sputtering method. Two pieces of the ITO/glass substrates are prepared, and used as a first substrate and a second substrate. The first substrate and the second substrate are placed to face each other via a 50 μm TEFLON (registered trademark) sheet as a spacer, then this structure is fixed with a clip.

Thereafter, a mixture of 10 parts by weight of the white particle dispersion liquid, 5 parts by weight of the cyan particle C1 dispersion liquid, 5 parts by weight of the magenta particle M1 dispersion liquid, and 2 parts by weight of the large yellow particles Y3 is injected into the spacer portion of the substrates, thereby obtaining an evaluation cell.

Using this evaluation cell, when a voltage of 30V is applied to the electrodes for 1 second such that the second electrode is positive, the magenta particles move to the positive side electrode, i.e., the second electrode side, and the cyan particles and the yellow particles move to the negative side electrode, i.e., the first electrode side. A magenta color is observed from the second substrate side.

Then, when a voltage of 30 V is applied to the electrodes for 1 second such that the second electrode is negative, the magenta particles move to the positive side electrode, i.e., the first electrode side, and the cyan particles and the yellow particles move to the negative side electrode, i.e., the second electrode side. A green color is observed from the second substrate side.

While a magenta color is observed from the second substrate side, when a voltage of 30 V is applied to the electrodes for 0.5 seconds and a voltage of 15 V is applied for 1 second such that the second electrode is negative, the magenta particles, the cyan particles, and the yellow particles move to the first electrode side, i.e., the positive electrode side, as a flocculation. Then, a white color is observed from the second substrate side.

Then, when a voltage of 15 V is applied to the electrodes for 1 second such that the second electrode is positive, the magenta particles, the cyan particles, and the yellow particles move to the second electrode side, i.e., the positive electrode side, as a flocculation. A black color is observed from the second substrate side.

Then, when a voltage of 30 V is applied to the electrodes for 0.1 seconds such that the second electrode is positive, the yellow particles move to the negative side electrode, i.e., the first electrode side. A blue color is observed from the second substrate side.

While a white color is observed from the second substrate side, when a voltage of 30 V is applied to the electrodes for 0.1 seconds such that the second electrode is negative, the yellow particles move to the negative side electrode, i.e., the second electrode side. A yellow color is observed from the second substrate side.

While a magenta color is observed from the second electrode side, when a voltage of 30 V is applied to the electrodes for 0.1 seconds such that the second electrode is negative, the yellow particles move to the second electrode side, i.e., the negative electrode side. A red color is observed from the second substrate side.

While a green color is observed from the second electrode side, when a voltage of 30 V is applied to the electrodes for 0.1 seconds such that the second electrode is positive, the yellow particles move to the first electrode side, i.e., the negative electrode side. A cyan color is observed from the second substrate side.

### Example 5

An ITO electrode is formed on a 0.7 mm thick glass plate as a substrate, to a thickness of 50 nm by a sputtering method. Two pieces of the ITO/glass substrates are prepared, and used as a first substrate and a second substrate. The first substrate and the second substrate are placed to face each other via a 50 μm TEFLON (registered trademark) sheet as a spacer, then this structure is fixed with a clip.

Thereafter, a mixture of 10 parts by weight of the white particle dispersion liquid, 5 parts by weight of the cyan particle C1 dispersion liquid, 2 parts by weight of the large magenta particles M2, and 2 parts by weight of the large yellow particles Y3 is injected into the spacer portion of the substrates, thereby obtaining an evaluation cell.

Using this evaluation cell, when a voltage of 30 V is applied to the electrodes for 1 second such that the second electrode is positive, the magenta particles move to the positive side electrode, i.e., the second electrode side, and the cyan particles and the yellow particles move to the negative side electrode, i.e., the first electrode side. A magenta color is observed from the second substrate side.

When a voltage of 30 V is applied to the electrodes for 1 second such that the second electrode is negative, the magenta particles move to the positive side electrode, i.e., the first electrode side, and the cyan particles and the yellow particles move to the negative side electrode, i.e., the second electrode side. A green color is observed from the second substrate side.

While a magenta color is observed from the second electrode side, when a voltage of 30 V is applied to the electrodes for 0.5 seconds and a voltage of 15 V is applied for 1 second such that the second electrode is negative, the magenta particles, the cyan particles, and the yellow particles move to the first electrode side, i.e., the positive electrode side, as a flocculation. A white color is observed from the second substrate side.

Then, when a voltage of 15 V is applied to the electrodes for 1 second such that the second electrode is negative, the magenta particles, the cyan particles, and the yellow particles move to the second electrode side, i.e., the positive electrode side, as a flocculation. A black color is observed from the second substrate side.

Then, when a voltage of 30 V is applied to the electrodes for 0.1 seconds such that the second electrode is positive, the yellow particles move to the negative side electrode, i.e., the first electrode side. A blue color is observed from the second substrate side.

While a white color is observed from the second electrode side, when a voltage of 30 V is applied to the electrodes for 0.1 seconds such that the second electrode is negative, the yellow particles move to the negative side electrode, i.e., the second electrode side. A yellow color is observed from the second substrate side.

While a magenta color is observed from the second electrode side, when a voltage of 30 V is applied to the electrodes for 0.1 seconds such that the second electrode is negative, the yellow particles move to the second electrode side, i.e., the negative electrode side. A red color is observed from the second substrate side.

While a green color is observed from the second substrate side, when a voltage of 30 V is applied to the electrodes for 0.1 seconds such that the second electrode is positive, the yellow particles move to the first electrode side, i.e., the negative electrode side. A cyan color is observed from the second substrate side.

### Comparative Example 1

—Silicone Polymer C—

A silicone polymer C is prepared in the same manner as the synthesis of the silicone polymer A, except that 48 parts by weight of SILAPLANE FM-0725 alone are used in place of SILAPLANE FM-0725 and SILAPLANE FM-0721, and 1 part by weight of phenoxy ethylene glycol acrylate (AMP-10G, trade name, manufactured by Shin-Nakamura Chemical Co., Ltd.) is used.

—Silicone Polymer D—

A silicone polymer D is prepared in the same manner as the synthesis of the silicone polymer B, except that 48 parts by weight of SILAPLANE FM-0725 alone are used in place of SILAPLANE FM-0725 and SILAPLANE FM-0721, and 1 part by weight of methyl methacrylate (manufactured by Wako Pure Chemical Industries, Ltd.) and 13 parts by weight of octafluoropentyl methacrylate (manufactured by Wako Pure Chemical Industries, Ltd.) are used.

—Synthesis of Cyan Electrophoretic Particles C2—

Cyan electrophoretic particles C2 are synthesized in the same manner as the synthesis of the cyan electrophoretic particles C1, except that the silicone polymer C is used in place of the silicone polymer A.

The volume average particle diameter of the obtained cyan particles is 0.2 μm.

—Synthesis of Magenta Electrophoretic Particles M3—

Magenta electrophoretic particles M3 are prepared in the same manner as the preparation of the magenta electrophoretic particles M1, except that the silicone polymer D is used in place of the silicone polymer B.

The volume average particle diameter of the obtained magenta particles is 0.3 μm.

An ITO electrode is formed on a 0.7 mm thick glass plate as a substrate, to a thickness of 50 nm by a sputtering method. Two pieces of the ITO/glass substrates are prepared, and used as a first substrate and a second substrate. The first substrate and the second substrate are placed to face each other via a 50 μm TEFLON (registered trademark) sheet as a spacer, then this structure is fixed with a clip.

Thereafter, a mixture of 10 parts by weight of the white particle dispersion liquid, 5 parts by weight of the cyan particle C2 dispersion liquid, and 5 parts by weight of the magenta particle M3 dispersion liquid is injected into the spacer portion of the substrates, thereby obtaining an evaluation cell.

Using this evaluation cell, a voltage of 30V is applied to the electrodes for 1 second such that the second electrode is positive. The dispersed negatively charged magenta particles move to the positive side electrode, i.e., the second electrode side, and the positively charged cyan particles move to the negative side electrode, i.e., the first electrode side. A magenta color is observed from the second substrate side.

Then, when a voltage of 30 V is applied to the electrodes for 1 second such that the second electrode is negative, the magenta particles move to the positive side electrode, i.e., the first electrode side, and the cyan particles move to the negative side electrode, i.e., the second electrode side. A cyan color is observed from the second substrate side.

Then, when a voltage of 30 V is applied to the electrodes for 0.5 seconds and subsequently a voltage of 15 V is applied for 1 second such that the second electrode is positive, the magenta particles move to the second electrode side, i.e., the positive side electrode, and the cyan particles move to the negative side electrode, i.e., the first electrode side. Then, a magenta color is observed from the second substrate side.

Then, when a voltage of 30 V is applied to the electrodes for 0.5 seconds and subsequently a voltage of 15 V is applied for 1 second such that the second electrode is negative, the magenta particles move to the first electrode side, i.e., the positive side electrode, and the cyan particles move to the negative side electrode, i.e., the second electrode side. A cyan color is observed from the second substrate side.

As seen from the above, the particles used in the comparative example do not flocculate, and thus a white color is not observed.

In the above description, the display device according to the exemplary embodiments is described, but the present invention is not limited to these exemplary embodiments.

For example, four or more kinds of electrophoretic particles in which at least two kinds of particles form a flocculation may be used. Exemplary combinations of the four kinds of electrophoretic particles include a combination in which two kinds of particles form a flocculation while the other two kinds of particles do not, a combination in which two kinds of particles among the three particles form a flocculation with different flocculating forces, respectively, and the remaining one kind of particles do not form a flocculation with the other kinds of particles, and a combination in which two kinds of particles among the four kinds of particles form a flocculation, and the other two kinds of particles form a flocculation with a different flocculating force from that of the previously mentioned two kinds of particles.

Further, the particles that do not electrophoretically migrate are not limited to white particles, and black particles may be used, for example.

All publications, patent applications, and technical standards mentioned in this specification are herein incorporated by reference to the same extent as if each individual publication, patent application, or technical standard was specifically and individually indicated to be incorporated by reference.

What is claimed is:

1. A display device comprising a display medium comprising:
a pair of substrates positioned so as to have a space therebetween, at least one of the substrates having translucency;
a pair of electrodes respectively being positioned on the pair of substrates, the electrode positioned on the substrate having translucency having translucency;
a dispersion medium positioned between the pair of electrodes; and
at least two kinds of particles being dispersed in the dispersion medium, the at least two kinds of particles comprising first particles and second particles having different colors and different charge polarities,
the first particles and the second particles electrophoretically moving independently from each other when a first voltage potential difference is applied between the pair of electrodes,
the first particles and the second particles electrophoretically moving while forming a positively or negatively charged flocculation when a second voltage potential difference that is smaller than the first voltage potential difference is applied between the pair of electrodes, and
the display device performing voltage application comprising:
applying the first voltage potential difference to the pair of electrodes at which the first particles and the second particles electrophoretically move independently from each other and are attracted to either one of the pair of electrodes depending on the charge polarity of the first particles and the second particles, respectively; and
applying the second voltage potential difference to the pair of electrodes at which the first particles and the second particles electrophoretically move while forming a positively or negatively charged flocculation, and the flocculation is attracted to either one of the pair of electrodes depending on the charge polarity of the flocculation.

2. The display device according to claim 1, wherein the at least two kinds of particles comprise third particles that electrophoretically move independently in response to a voltage potential difference applied to the pair of electrodes, the third particles being dispersed in the dispersion medium and having a flocculating force with respect to the first particles and the second particles that is different from a flocculating force of the flocculation formed by the first particles and the second particles.

3. The display device according to claim 2, wherein the third particles electrophoretically move while forming a positively or negatively charged flocculation with the first particles and the second particles when a certain voltage is applied between the pair of electrodes, and wherein the display device performs:
application of a voltage at which the first particles and the second particles electrophoretically move while forming a flocculation and the flocculation is attracted to either one of the pair of electrodes depending on the charge polarity of the flocculation; and
application of a voltage at which the first particles, the second particles and the third particles electrophoretically move while forming a flocculation and the flocculation is attracted to either one of the pair of electrodes depending on the charge polarity of the flocculation.

4. The display device according to claim 3, wherein the first particles and the second particles can move through the third particles, and wherein the third particles have a higher responsiveness to a voltage potential difference applied between the pair of electrodes than the first particles and the second particles.

5. The display device according to claim 2, wherein the first particles and the second particles can move through the third particles, and wherein the third particles electrophoretically move without forming a flocculation with the first particles and the second particles, and have a higher responsiveness to a voltage applied between the pair of electrodes than the first particles and the second particles.

6. The display device according to claim 2, wherein the diameter of the third particles is at least 10 times as large as the diameters of the first particles and the second particles.

7. The display device according to claim 3, wherein the diameter of the third particles is at least 10 times as large as the diameters of the first particles and the second particles.

8. The display device according to claim 4, wherein the diameter of the third particles is at least 10 times as large as the diameters of the first particles and the second particles.

9. The display device according to claim 5, wherein the diameter of the third particles is at least 10 times as large as the diameters of the first particles and the second particles.

10. The display device according to claim 2, wherein the at least two particles comprise colored particles containing a polymer having a charging group and a colorant, and a reactive silicone polymer or a reactive long chain alkyl polymer that is bound to the surface of the colored particles or covers the surface of the colored particles.

11. The display device according to claim 3, wherein the at least two particles comprise colored particles containing a polymer having a charging group and a colorant, and a reactive silicone polymer or a reactive long chain alkyl polymer that is bound to the surface of the colored particles or covers the surface of the colored particles.

12. The display device according to claim 4, wherein the at least two particles comprise colored particles containing a polymer having a charging group and a colorant, and a reactive silicone polymer or a reactive long chain alkyl polymer that is bound to the surface of the colored particles or covers the surface of the colored particles.

13. The display device according to claim 5, wherein the at least two particles comprise colored particles containing a polymer having a charging group and a colorant, and a reactive silicone polymer or a reactive long chain alkyl polymer that is bound to the surface of the colored particles or covers the surface of the colored particles.

14. The display device according to claim 2, further comprising particles that do not electrophoretically move.

15. The display device according to claim 3, further comprising particles that do not electrophoretically move.

16. The display device according to claim 4, further comprising particles that do not electrophoretically move.

17. The display device according to claim 5, further comprising particles that do not electrophoretically move.
